(19) United States
(12) Patent Application Publication
(10) Pub. No.: US 2010/0181285 A1
(43) Pub. Date: Jul. 22, 2010

(54) Method of manufacturing capacitor device

(75) Inventor: Hironori Tanaka, Ogaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: IBIDEN, CO., LTD., Ogaki-shi (JP)

(21) Appl. No.: 12/585,679

(22) Filed: Sep. 22, 2009

Related U.S. Application Data
(60) Provisional application No. 61/194,673, filed on Sep. 30, 2008.

(51) Int. Cl. B44C 1/22

(52) U.S. Cl. 216/17

(57) ABSTRACT

A method of manufacturing a capacitor device includes forming at least one through-hole in a capacitor laminate formed with laminated multiple capacitors, conducting a dry desmear treatment in the at least one through-hole after forming the at least one through-hole, and forming seed metal through dry processing in the at least one through-hole after conducting the dry desmear treatment.

### CROSS-REFERENCE TO RELATED APPLICATIONS

The present application claims the benefits of priority to U.S. Application No. 61/194,673, filed Sep. 30, 2008. The contents of that application are incorporated herein by reference in their entirety.

### BACKGROUND

### Field of the Invention

The present invention is related to a method of manufacturing a capacitor device for a wiring board with a built-in capacitor, for example.

In response to demand for compact electronic devices, it is required that mounting efficiency be enhanced for electronic components that form electronic devices. Accordingly, a wiring board with a built-in capacitor is disclosed in Japanese Laid-Open Patent Publication 2005-191559.

### [Patent Publication (1)] Japanese Laid-Open Patent Publication 2005-191559

### [Patent Publication (2)] Japanese Laid-Open Patent Publication 2004-228190

The contents of these publications are incorporated herein by reference in their entirety.

### SUMMARY

The present invention is intended to solve the above problems. Its objective is to provide a method of manufacturing a capacitor device so that a capacitor device having high capacity and secured insulation resistance may be manufactured. Also, its other objective is to provide a method of manufacturing a capacitor device so as to maintain productivity of wiring boards with built-in capacitor laminates in which such capacitors are laminated.

A method of manufacturing a capacitor device, including forming at least one through-hole in a capacitor laminate made up of a plurality of laminated capacitors, conducting a dry desmear treatment in the through-hole after forming the at least one through-hole; and forming seed metal through dry processing in the at least one through-hole after conducting the dry desmear treatment.

A method of manufacturing a capacitor device, including forming a capacitor having a dielectric layer, and a first electrode and a second electrode facing each other, with the dielectric layer being in between the first and second electrodes, forming a capacitor laminate by laminating the capacitors with an adhesive agent, forming on a support plate, first external connection terminals having a first external terminal and a second external terminal, alternately laminating a plurality of resin insulation layers and a plurality of conductive circuits on the first external connection terminals and the support plate, embedding the capacitor laminate in at least one resin insulation layer among the plurality of resin insulation layers, forming in the capacitor laminate, at least one through-hole penetrating either first electrodes and second electrodes, conducting a dry desmear treatment in the at least one through-hole, forming seed metal through dry processing in the at least one through-hole after conducting the dry desmear treatment, forming a first via conductor electrically connecting the first electrodes with each other, and a second via conductor electrically connecting the second electrodes with each other, by plating on the seed metal after forming the seed-metal and filling the at least one through-hole with metal conductor; and forming a third external terminal electrically connected to the first via conductor, and a fourth external terminal electrically connected to the second via conductor.

A method of manufacturing a capacitor device, including forming a capacitor having a dielectric layer, and a first electrode and a second electrode facing each other, with the dielectric layer being in between the first and second electrodes, forming a capacitor laminate by laminating the capacitors with an adhesive agent, forming on a support plate, first external connection terminals having a first external terminal and a second external terminal, alternately laminating a plurality of resin insulation layers and a plurality of conductive circuits on the first external connection terminals and the support plate, embedding the capacitor laminate in at least one resin insulation layer among the plurality of resin insulation layers, forming in the capacitor laminate, at least one through-hole penetrating either first electrodes and second electrodes, conducting a dry desmear treatment in the at least one through-hole, forming seed metal through dry processing in the at least one through-hole after conducting the dry desmear treatment, forming a first via conductor electrically connecting the first electrodes with each other, and a second via conductor electrically connecting the second electrodes with each other, by plating on the seed metal after forming the seed-metal and filling the through-hole with metal conductor, forming second external connection terminals having a third external terminal and a fourth external terminal on a resin insulation layer positioned uppermost among the plurality of resin insulation layers and opposite the support plate, and removing the support plate, wherein the first external terminal and the third external terminal are electrically connected to the first via conductor, and the second external terminal and the fourth external terminal are electrically connected to the second via conductor.

According to the present invention, a capacitor device having a high capacity and secured insulation resistance may be manufactured. Also, productivity may be increased when manufacturing a wiring board with a built-in capacitor laminate made by laminating capacitors.

### BRIEF DESCRIPTION OF THE DRAWINGS

The patent or application file contains at least one drawing executed in color. Copies of this patent or patent application publication with color drawings will be provided by the office upon request and payment of the necessary fee.

A more complete appreciation of the invention and many of the attendant advantages thereof will be readily obtained as the same becomes better understood by reference to the following detailed description when considered in connection with the accompanying drawings, wherein:

FIG. (1) is a cross-sectional view of a capacitor device (wiring board) according to the First Embodiment of the present invention.

FIG. (2A) is a view to illustrate a step for manufacturing a wiring board according to the First Embodiment in which a first electrode, a dielectric layer and a second electrode are laminated;

FIG. (2B) is a view to illustrate a step for manufacturing a wiring board according to the First Embodiment in which the first electrode and the second electrode are positioned to be shifted from each other;

FIG. (2C) is a view to illustrate a step for manufacturing a wiring board according to the First Embodiment in which a capacitor laminate is formed by laminating capacitors;

FIG. (2D) is a view to illustrate a step for manufacturing a wiring board according to the First Embodiment in which the capacitor laminate is formed by laminating the capacitors with an adhesive agent;

FIG. (2E) is a view to illustrate a step for manufacturing a wiring board according to the First Embodiment in which a resin insulation layer is laminated on a base substrate;

FIG. (2F) is a view to illustrate a step for manufacturing a wiring board according to the First Embodiment in which the capacitor laminate is to be embedded in the resin insulation layer;

FIG. (2G) is a view to illustrate a step for manufacturing a wiring board according to the First Embodiment, showing the resin insulation layer where the capacitor laminate is embedded;

FIG. (2H) is a view to illustrate a step for manufacturing a wiring board according to the First Embodiment in which a capacitor laminate is laminated on the resin insulation layer;

FIG. (2I) is a view to illustrate a step for manufacturing a wiring board according to the First Embodiment in which a second resin insulation layer is further laminated on the resin insulation layer;

FIG. (2J) is a view to illustrate a step for manufacturing a wiring board according to the First Embodiment in which through-holes for via conductors are formed in the capacitor laminate;

FIG. (2K) is a view seen from above to illustrate the capacitor laminate of the wiring board according to the First Embodiment;

FIG. (2L) is a view seen from above to illustrate the capacitor laminate of the wiring board according to the First Embodiment;

FIG. (2M) is a view to illustrate a step for manufacturing a wiring board according to the First Embodiment in which conductive patterns are formed on the second resin insulation layer;

FIG. (2N) shows views to illustrate a short-circuiting phenomenon between capacitor electrodes due to a damaged dielectric layer;

FIG. (2O) shows photographs to illustrate a short-circuiting phenomenon between capacitor electrodes due to a damaged dielectric layer;

FIG. (2P) shows views to illustrate an example of a capacitor device manufactured by means of a wet desmear treatment;

FIG. (2Q) is a photograph to show an example of a capacitor device manufactured by means of a wet desmear treatment;

FIG. (2R) shows views to illustrate an example of a capacitor device manufactured by means of a dry desmear treatment;

FIG. (2S) is a photograph showing an example of a capacitor device manufactured by means of a dry desmear treatment;

FIG. (2T) is a view to illustrate a step for manufacturing a wiring board according to the First Embodiment in which a third resin insulation layer is further laminated;

FIG. (2U) is a view to illustrate a step for manufacturing a wiring board according to the First Embodiment in which conductive patterns are formed on the third resin insulation layer;

FIG. (2V) is a view to illustrate a step for manufacturing a wiring board according to the First Embodiment in which multiple opening portions are formed in a solder resist;

FIG. (2W) is a view to illustrate a step for manufacturing a wiring board according to the First Embodiment in which an IC chip is mounted by means of solder bumps; and

FIG. (2X) is a view to illustrate a step for manufacturing a wiring board according to the First Embodiment in which resin insulation layers are also formed on the lower surface of the base substrate.

FIG. (3) is a cross-sectional view of a capacitor device (wiring board) according to the Second Embodiment of the present invention.

FIG. (4A) is a view to illustrate a step for manufacturing a wiring board according to the Second Embodiment in which through-holes for via conductors are formed in a capacitor laminate;

FIG. (4B) is a view to illustrate a step for manufacturing a wiring board according to the Second Embodiment in which conductive patterns are formed on the upper surface of the capacitor laminate and the resin insulation layer;

FIG. (4C) is a view to illustrate a step for manufacturing a wiring board according to the Second Embodiment in which a second resin insulation layer is further formed; and

FIG. (4D) is a view to illustrate a step for manufacturing a wiring board according to the Second Embodiment in which a resin insulation layer is also formed on the lower surface of the base substrate.

FIG. (5) is a cross-sectional view of a capacitor device (wiring board) according to the Third Embodiment, showing a capacitor laminate in which via conductors are formed in the opening portions of a first electrode and a second electrode.

FIG. (6A) is a view to illustrate via conductors that penetrate the capacitor laminate of the wiring board according to the Third Embodiment in such a way that they configure a grid pattern; and

FIG. (6B) is a view to illustrate via conductors that penetrate the capacitor laminate of the wiring board according to the Third Embodiment in such a way that they configure a zigzag pattern.

FIG. (7A) is a view to illustrate a single capacitor unit of a wiring board according to the Third Embodiment in which a first electrode, a dielectric layer and a second electrode are laminated;

FIG. (7B) is a view to illustrate a single capacitor unit of a wiring board according to the Third Embodiment where the first electrode and the second electrode are patterned;

FIG. (7C) is a plan view seen from the side of the first electrode to illustrate the patterned capacitor of a wiring board according to the Third Embodiment;

FIG. (7D) is a plan view seen from the side of the second electrode to illustrate the patterned capacitor of a wiring board according to the Third Embodiment;

FIG. (7E) is a view to illustrate a step for manufacturing a wiring board according to the Third Embodiment in which a capacitor laminate is formed by laminating patterned capacitors;

FIG. (7F) is a view to illustrate a step for manufacturing a wiring board according to the Third Embodiment, showing a capacitor laminate in which patterned capacitors are laminated with an adhesive agent;

FIG. (7G) is a view to illustrate a step for manufacturing a wiring board according to the Third Embodiment in which the capacitor laminate formed by laminating the patterned capacitors is embedded in a resin insulation layer;

FIG. (7H) is a view to illustrate a step for manufacturing a wiring board according to the Third Embodiment in which through-holes are formed in the capacitor laminate formed by laminating the patterned capacitors; and

FIG. (7I) is a view to illustrate a step for manufacturing a wiring board according to the Third Embodiment in which via conductors and conductive patterns are formed in the capacitor laminate formed by laminating the patterned capacitors.

FIG. (8) is a cross-sectional view of a capacitor device (wiring board) according to the Fourth Embodiment of the present invention.

FIG. (9A) is a view to illustrate a support plate which supports a resin insulation layer in the process of manufacturing a wiring board according to the Fourth Embodiment;

FIG. (9B) is a view to illustrate a step to form a plating resist on the support layer in the process of manufacturing a wiring board according to the Fourth Embodiment;

FIG. (9C) is a view to illustrate a step to form multiple opening portions in the plating resist formed on the support layer in the process of manufacturing a wiring board according to the Fourth Embodiment;

FIG. (9D) is a view to illustrate a step for manufacturing a wiring board according to the Fourth Embodiment in which external terminals are formed in the opening portions of the plating resist;

FIG. (9E) is a view to illustrate a step for manufacturing a wiring board according to the Fourth Embodiment in which a first resin insulation layer is formed on the support plate;

FIG. (9F) is a view to illustrate a step for manufacturing a wiring board according to the Fourth Embodiment in which through-holes are formed in the first resin insulation layer formed on the support plate;

FIG. (9G) is a view to illustrate a step for manufacturing a wiring board according to the Fourth Embodiment in which conductive patterns are formed on the upper surface of the first resin insulation layer;

FIG. (9H) is a view to illustrate a step for manufacturing a wiring board according to the Fourth Embodiment in which a second resin insulation layer is formed on the first resin insulation layer;

FIG. (9I) is a view to illustrate a step for manufacturing a wiring board according to the Fourth Embodiment in which a capacitor laminate is to be embedded in the second resin insulation layer;

FIG. (9J) is a view to illustrate a step for manufacturing a wiring board according to the Fourth Embodiment, showing the second resin insulation layer where the capacitor laminate is embedded;

FIG. (9K) is a view to illustrate a step for manufacturing a wiring board according to the Fourth Embodiment in which through-holes are formed in the second resin insulation layer where the capacitor laminate is embedded;

FIG. (9L) is a view to illustrate a step for manufacturing a wiring board according to the Fourth Embodiment in which via conductors are formed in the second resin insulation layer and conductive patterns are formed on the layer;

FIG. (9M) is a view to illustrate a step for manufacturing a wiring board according to the Fourth Embodiment in which a third resin insulation layer is formed on the second resin insulation layer;

FIG. (9N) is a view to illustrate a step for manufacturing a wiring board according to the Fourth Embodiment in which through-holes are formed in the third resin insulation layer;

FIG. (9O) is a view to illustrate a step for manufacturing a wiring board according to the Fourth Embodiment in which via conductors are formed in the third resin insulation layer and conductive patterns are formed on the layer;

FIG. (9P) is a view to illustrate a step for manufacturing a wiring board according to the Fourth Embodiment in which a solder resist is formed on the third resin insulation layer;

FIG. (9Q) is a view to illustrate a step for manufacturing a wiring board according to the Fourth Embodiment in which external terminals are formed in the multiple opening portions formed in the solder resist; and

FIG. (9R) is a view to illustrate a step for manufacturing a wiring board according to the Fourth Embodiment in which the support plate is removed by etching.

FIG. (10) is a view showing a modified example of a wiring board according to the Fourth Embodiment of the present invention.

FIG. (11) is a cross-sectional view of a capacitor device (wiring board) according to the Fifth Embodiment where a capacitor laminate is also embedded in a resin insulation layer formed on the lower side of the base substrate.

FIG. (12) is a cross-sectional view of an example showing a capacitor device having a single capacitor layer.

### DETAILED DESCRIPTION

However, the inventors have recognized that in the wiring board disclosed in the publication, it is difficult to achieve high capacity while securing insulation resistance in the capacitor built into the wiring board.

The inventors also recognized that possible reasons for that are as follows: To achieve high capacity in a capacitor, the dielectric layer of the capacitor needs to be thin, but if the dielectric layer is made thin, the insulation resistance of the capacitor is reduced; on the other hand, to secure the insulation resistance of the capacitor, the dielectric layer needs to be thick, and in such a case, high capacity in the capacitor may not be achieved.

Also, a wiring board with multiple built-in capacitors formed by alternately laminating dielectric layers and electrodes is disclosed in Japanese Laid-Open Patent Publication 2004-228190. In the wiring board disclosed in the publication, the thickness of a dielectric layer is set to be sufficient for obtaining the insulation resistance of the capacitor, and the entire capacity is increased by arranging multiple capacitors.

However, the present inventors recognized that in the wiring board disclosed in the publication, if there is a flaw in a capacitor, it will cause the entire capacitor laminate to become defective.

The embodiments will now be described with reference to the accompanying drawings, wherein like reference numerals designate corresponding or identical elements throughout the various drawings.

### (First Embodiment of a Wiring Board According to the Present Invention)

In the following, an embodiment of the present invention is described with reference to the drawings.

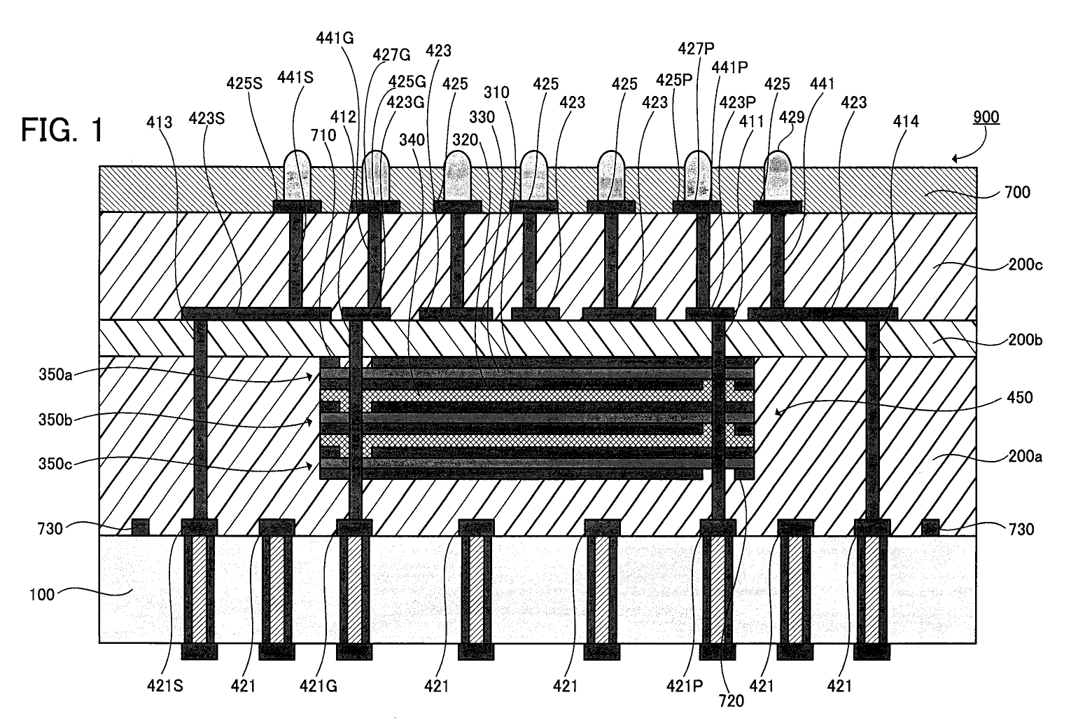

As shown in FIG. 1), wiring board (900) according to the present embodiment is formed with first resin insulation layer (200a), base substrate (100) that supports first resin insulation layer (200a), and capacitor laminate (450) embedded in first resin insulation layer (200a).

On first resin insulation layer (200a), second resin insulation layer (200b) is formed. On second resin insulation layer (200b), third resin insulation layer (200c) is formed.

The upper surface of capacitor laminate (450) is positioned at the upper surface of first resin insulation layer (200a), and the upper surface of capacitor laminate (450) and the upper surface of first resin insulation layer (200a) are made flush.

Capacitor laminate (450) is formed by laminating capacitors (350a, 350b, 350c) using adhesive agent (340) between them. Adhesive agent (340) is an insulative resin such as epoxy resin.

The thickness of capacitor laminate (450) is, for example, in the range of 30 μm to 100 μm. If the thickness is greater than 100 μm, it may be difficult to embed capacitor laminate (450) in resin insulation layer (200a). By contrast, if the thickness is less than 30 μm, the structure may become too fine, thus it may hamper efficiency in manufacturing wiring boards.

Capacitors (350a, 350b, 350c) each have dielectric layer (330), and slab-type first electrode (310) and second electrode (320). First electrode (310) and second electrode (320) are formed with a rectangular slab conductor of the same size. First electrode (310) and second electrode (320) are shifted from each other a predetermined distance in a direction parallel to their planar surfaces, but partially overlapping. First electrode (310) and second electrode (320) are, for example, 0.2 mm-8 mm long, 0.1 mm-8 mm wide and 3 μm-15 μm thick. First electrode (310) and second electrode (320) are made of copper.

Dielectric layer (330) is, for example, 0.5 μm-10 μm thick. If the thickness of dielectric layer (330) is less than 0.5 μm, the insulation resistance of the capacitor may possibly be lowered. On the other hand, if the thickness is greater than 10 μm, the capacity of the capacitor may not reach a sufficiently high level.

The distance between capacitors (350), for example the distance between second electrode (320) of capacitor (350a) and first electrode (310) of capacitor (350b) (namely, the thickness of the adhesive layer formed with adhesive agent (340)), is for example, in the range of 2-12 μm. If the distance is less than 2 μm, the amount of adhesive agent (340) filled between capacitors (350) is insufficient; thus it may weaken the adhesiveness between capacitors (350). Also, if the thickness of adhesive agent (340) is small, insulation resistance may become low between the capacitors (between (350a) and (350b), or between (350b) and (350c)). On the other hand, if the distance is greater than 12 μm, the fine wiring structure of the wiring board may be hampered due to an increase in the thickness of capacitor laminate (450).

Dielectric layer (330) is a dielectric layer made of ceramic. Dielectric layer (330) is formed with, for example, barium titanate (BaTiO₃). For dielectric layer (330), a thermoplastic resin or a thermosetting resin containing dielectric filler may be used. A thermoplastic resin such as polyester, and a thermosetting resin such as phenol resin may be used. Dielectric filler is made from, for example, strontium titanate (SrTiO₃).

First electrodes (310) of capacitors (350a, 350b, 350c) are electrically connected with each other through via conductors (411). Also, second electrodes (320) of capacitors (350a, 350b, 350c) are electrically connected with each other through via conductors (412).

On base substrate (100), multiple conductive patterns (conductive circuits) (421) (421P, 421G, 421S) are formed, and on second resin insulation layer (200b), multiple conductive patterns (423) (423P, 423G, 423S) are formed. On third resin insulation layer (200c), multiple conductive patterns (425) (425P, 4256, 425S) are formed

Via conductors (411) electrically connect conductive pattern (421P) and conductive pattern (423P). Via conductors (412) electrically connect conductive pattern (421G) and conductive pattern (423G). Conductive pattern (423G) connected to via conductors (412) is connected to a ground line, and conductive pattern (423P) connected to via conductors (411) is connected to a power-source line. Via conductors (441P) electrically connect conductive pattern (423P) and conductive pattern (425P). Via conductors (441G) electrically connect conductive pattern (423G) and conductive pattern (425G).

The thickness of base substrate (100) is in the range of 200 μm to 800 μm. Base substrate (100) is formed with, for example, glass epoxy resin. Glass epoxy resin is made by impregnating glass cloth with epoxy resin to which glass filler is added (glass epoxy substrate).

First resin insulation layer (200a), second resin insulation layer (200b) and third resin insulation layer (200c) are, for example, 40 μm-120 μm thick. Resin insulation layers (200a, 200b, 200c) are formed with, for example, a thermosetting resin such as epoxy resin. Resin insulation layers may be formed with inorganic particles such as glass, alumina or barium carbonate along with a thermosetting resin. A glass epoxy substrate may be made with two-layer glass cloth.

Wiring board (900) may process electrical signals in a variety of ways such as transmitting electrical signals through conductive pattern (421S) or the like.

Also, wiring board (900), in which capacitor laminate (450) is embedded in resin insulation layer (200a), may save space while achieving noise-decoupling.

Also, since capacitors may be arranged near an IC chip mounted on wiring board (900), delays in power supply to the IC may be prevented.

Also, capacitor laminate (450) built into resin insulation layer (200a) is formed by laminating capacitors (350). Thus, by keeping dielectric layer (330) of each capacitor (350) at a predetermined thickness while maintaining the insulation resistance of each capacitor (350) at an approximately constant level, an increase of capacity in the capacitors of the entire capacitor laminate (450) may be achieved, since multiple capacitors (350) are laminated. Accordingly, high capacity in the capacitors and high insulation performance of the capacitors may both be achieved.

Also, capacitor (350) is formed with first electrode (310) configured to be a slab, second electrode (320) shifted from first electrode (310) in a direction parallel to its planar surface, and dielectric layer (330). As such, since first electrode (310) and second electrode (320) of each capacitor (350) are formed by shifting them alternately, it is easier to form via conductors (411) electrically connecting first electrodes (310) and via conductors (412) electrically connecting second electrodes (320) of each capacitor (350a, 350b, 350c). Accordingly, since it is not necessary to form via conductors in the regions where first electrode (310) and second electrode (320) face each other, the electrode areas are increased, thus high capacity in the capacitors may be achieved. Moreover, since the number of via conductors that penetrate the electrodes of the capacitors is reduced, cracks in the dielectric layers caused by thermal expansion of the via conductors may be suppressed to the utmost.

Furthermore, capacitor laminate (450) is formed by laminating capacitors (350). Thus, when forming capacitor laminate (450), the insulation resistance values of each capacitor (350) are checked in advance, and only capacitors (350) having excellent insulation resistance may be selected to be laminated. As a result, the entire capacitor laminate (450) may also be made of high quality, and the insulation reliability of capacitor laminate (450) may be achieved. If a capacitor laminate is formed by alternately laminating electrodes and dielectric layers, it is difficult to check in advance to see whether or not the insulation resistance of each capacitor section is excellent. Accordingly, it is difficult to achieve insulation reliability in the capacitor laminate during the manufacturing process.

Moreover, in capacitor laminate (450) built into resin insulation layer (200a), capacitors (350) are laminated using adhesive agent (340) made of resin or the like. Materials to make the thermal expansion coefficient of the resin for adhesive agent (340) the same as the thermal expansion coefficient of resin insulation layer (200a) may be used. Accordingly, the thermal expansion coefficient of the entire capacitor laminate (450) may be set to approximate the thermal expansion coefficient of resin insulation layer (200a). Therefore, even if capacitor laminate (450) is heated, there is only a slight chance that cracks will occur at the interface of resin insulation layer (200a) and capacitor laminate (450). Accordingly, cracks seldom occur in dielectric layers (330).

### (A Method Of Manufacturing A Wiring Board According To The First Embodiment of the Present Invention)

First, on first electrode (310) made of 5 μm-thick copper, dielectric material made of BaTiO₃ is printed to make a thin film with a thickness of 5-10 μm using printing equipment such as doctor blades or the like, and an uncalcined layer is formed. Here, to form further thinner dielectric layers (0.5-5 μm), later-described methods such as a sol-gel method or sputtering may be used.

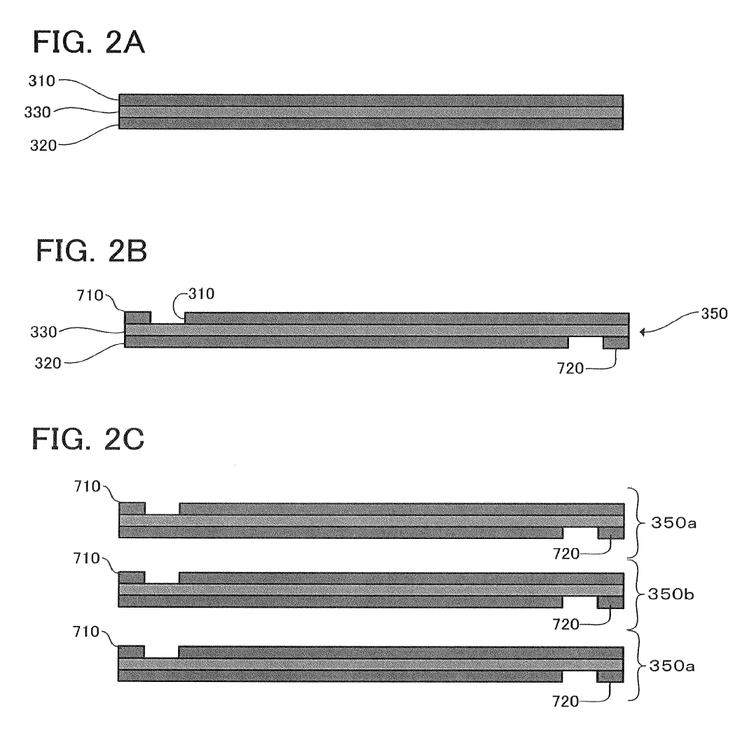

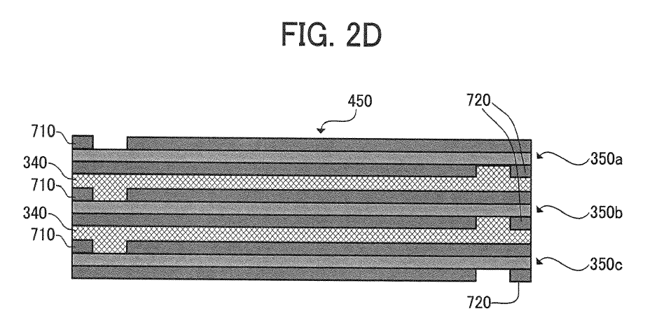

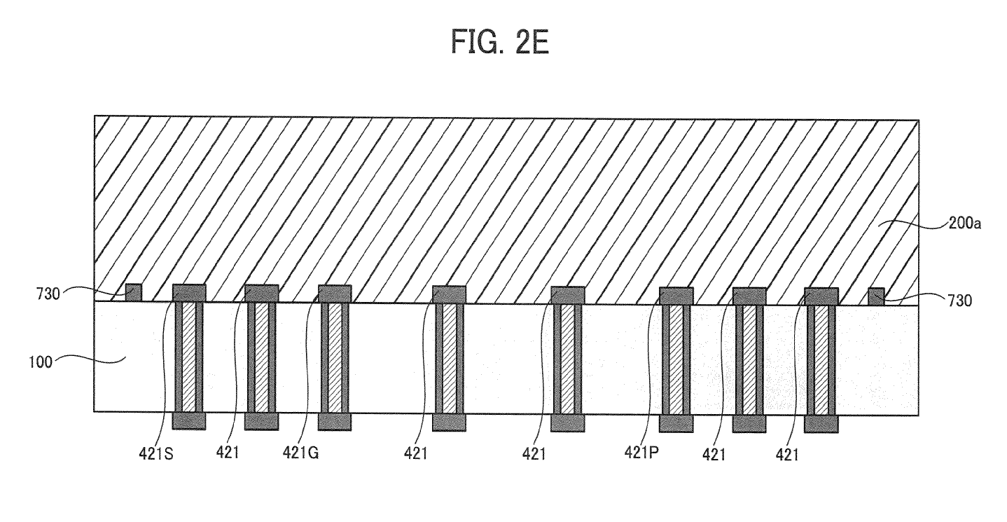

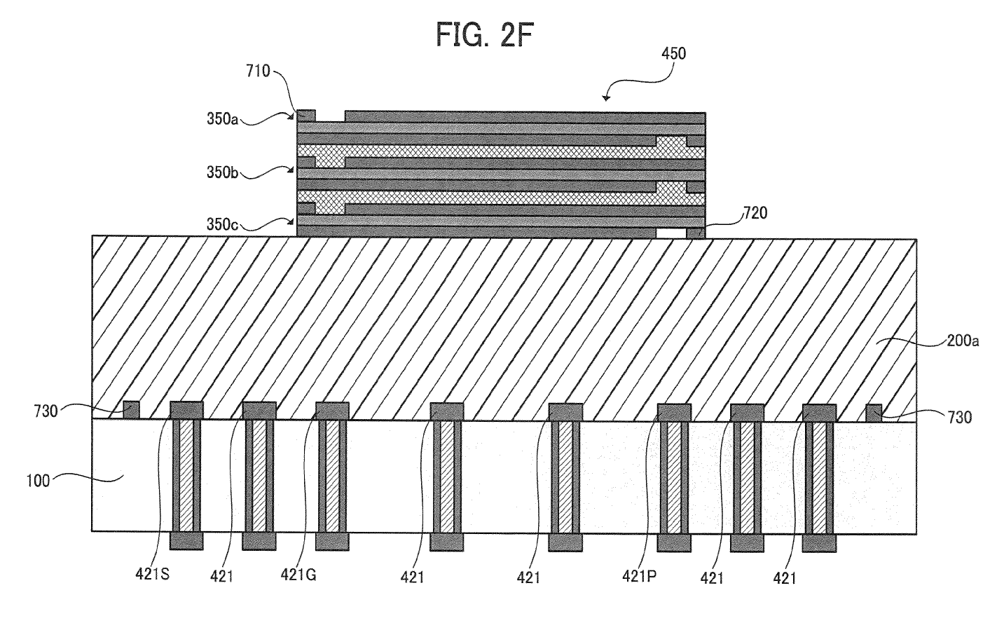

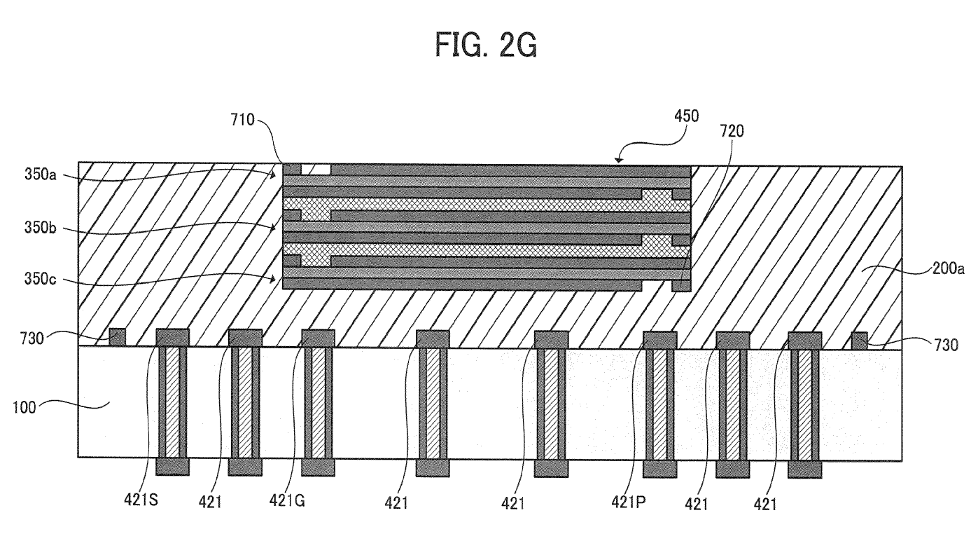

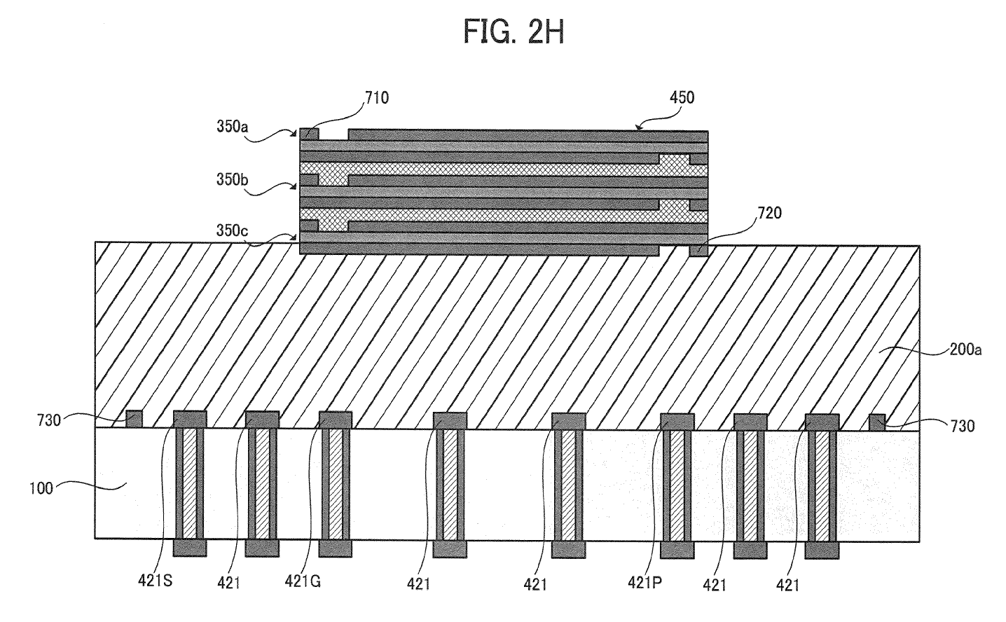

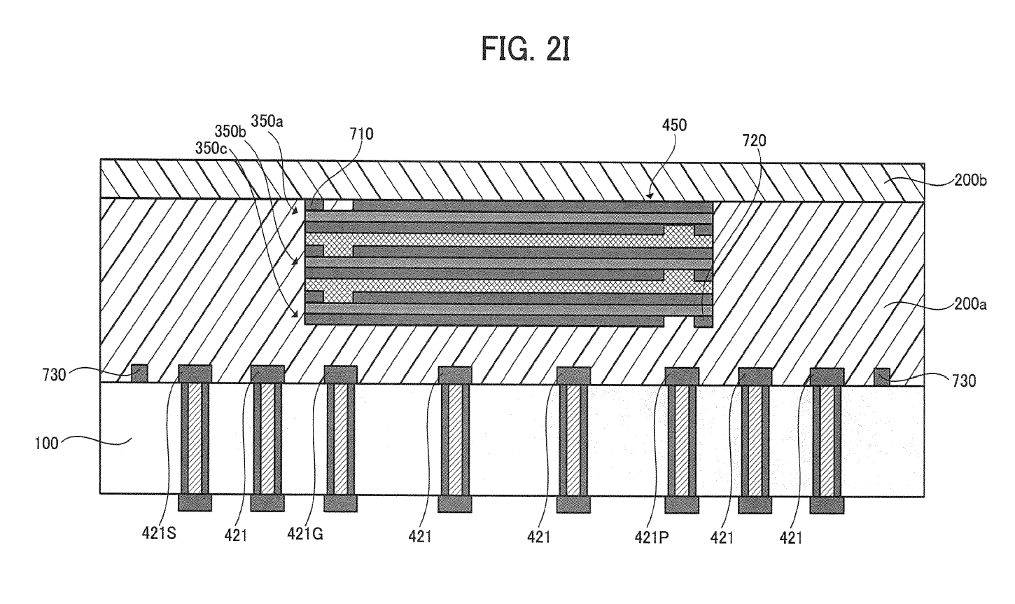

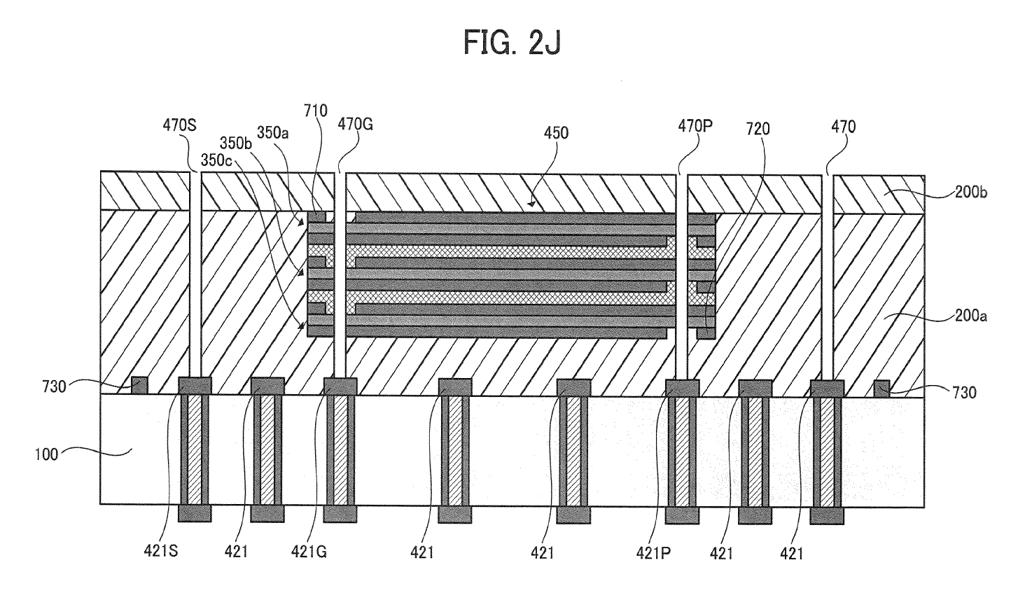

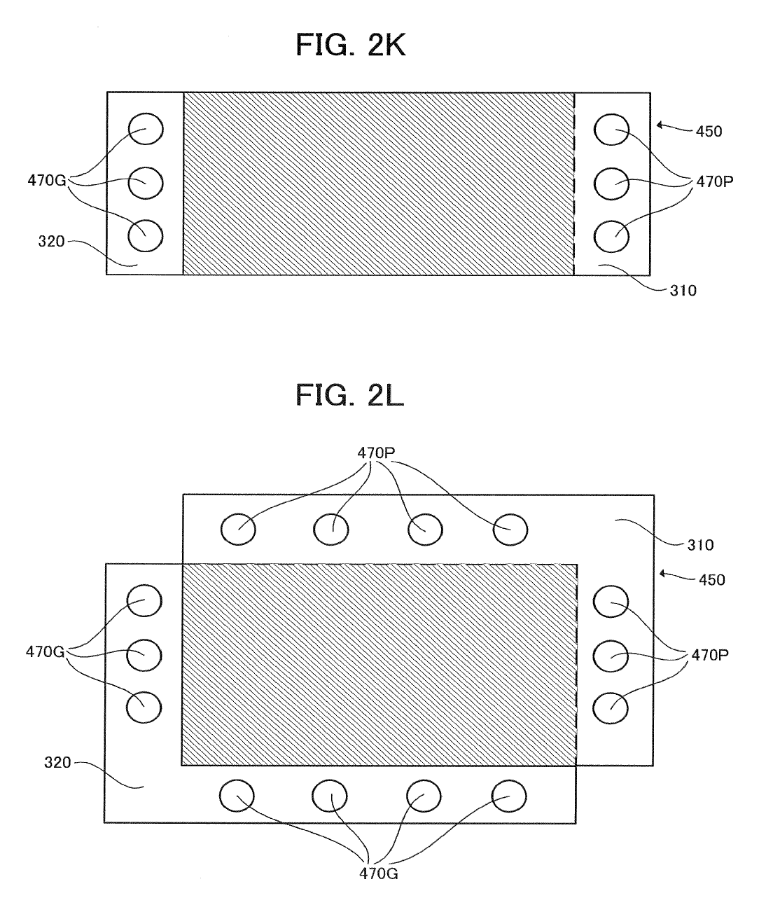

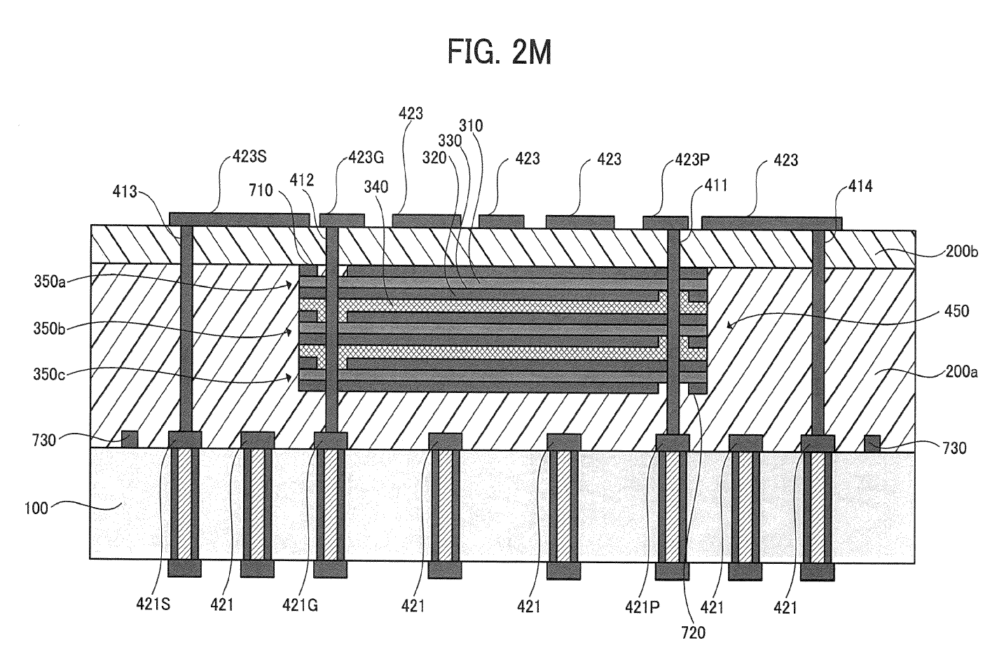

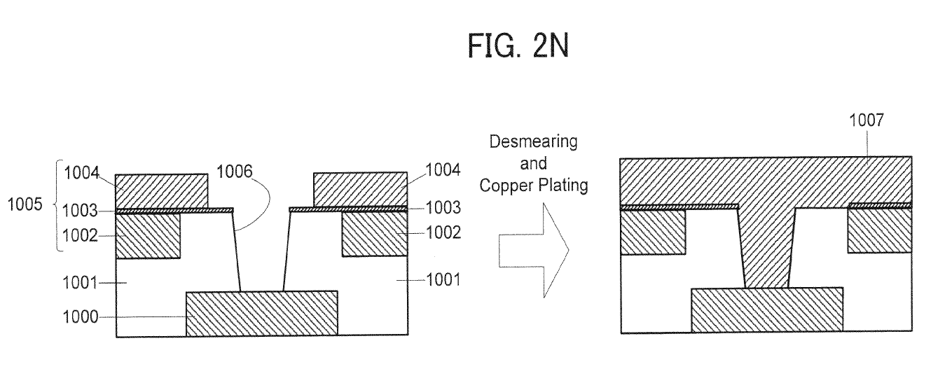

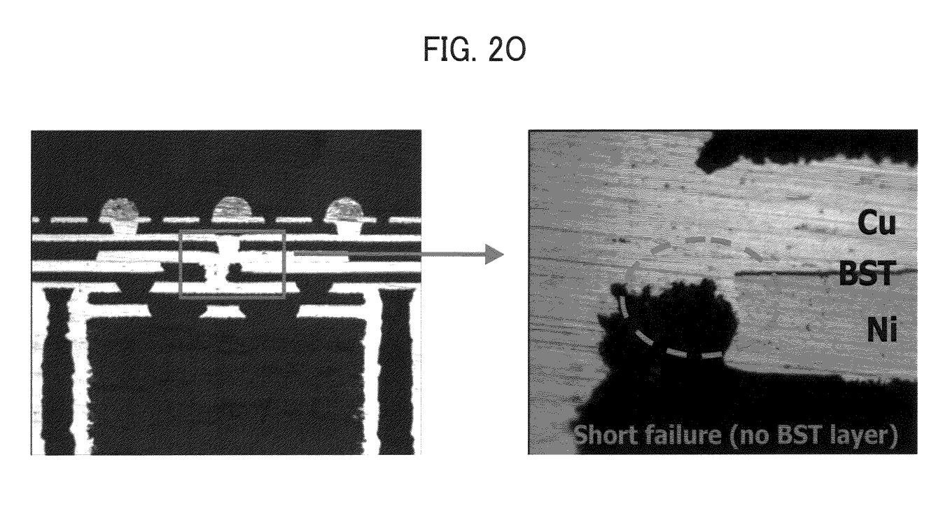

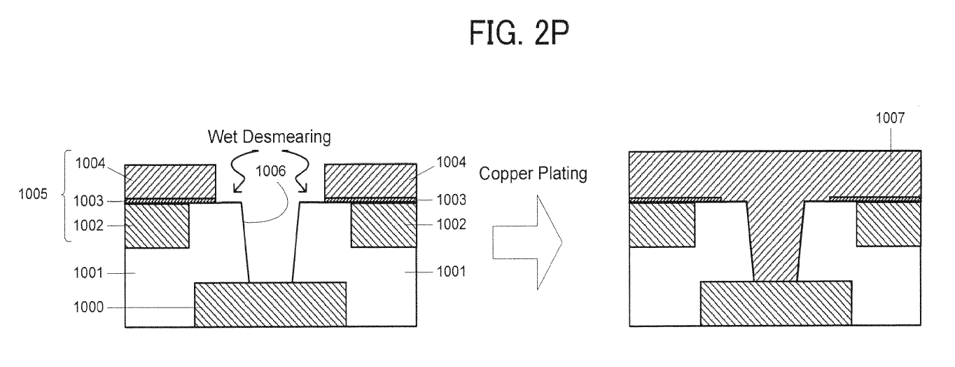

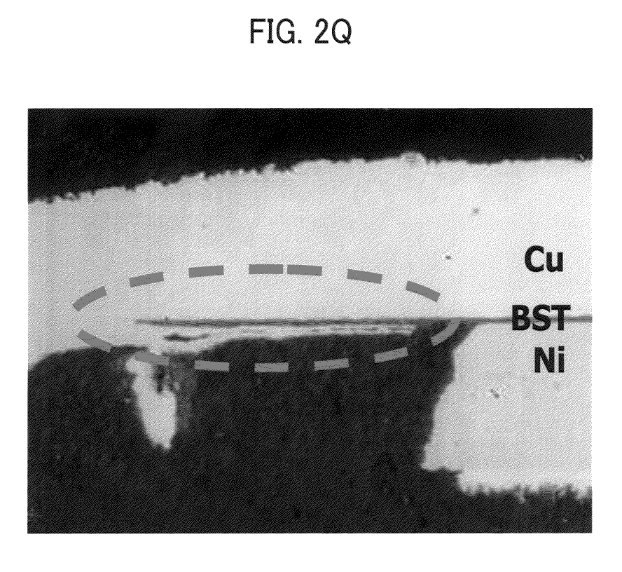

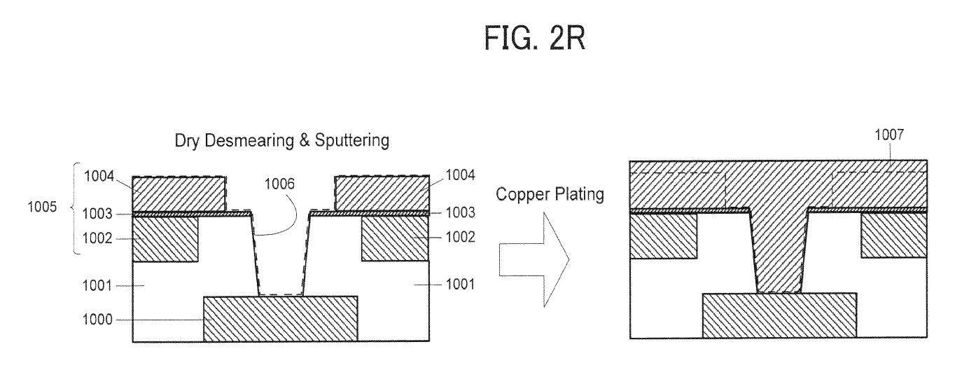

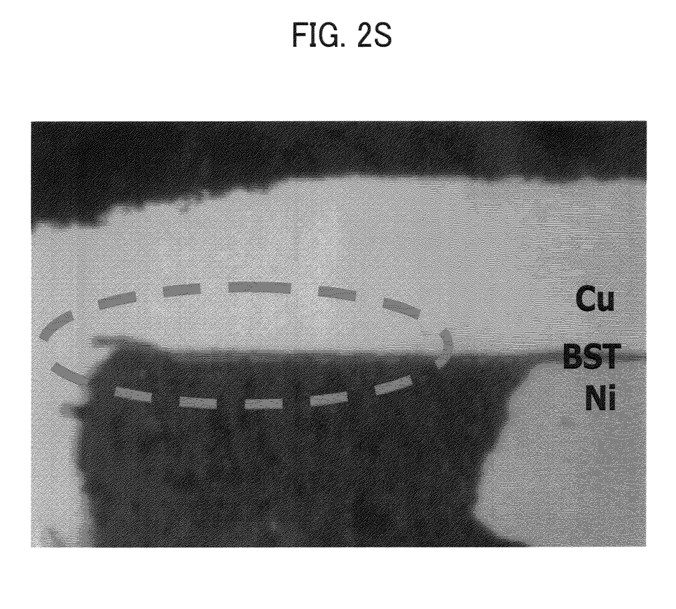

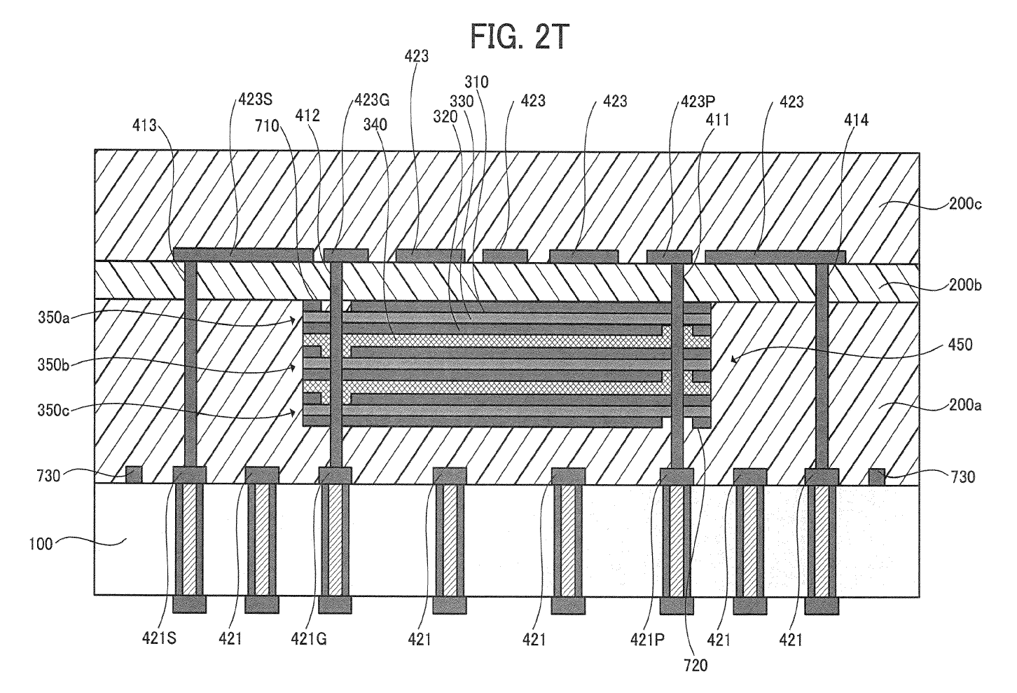

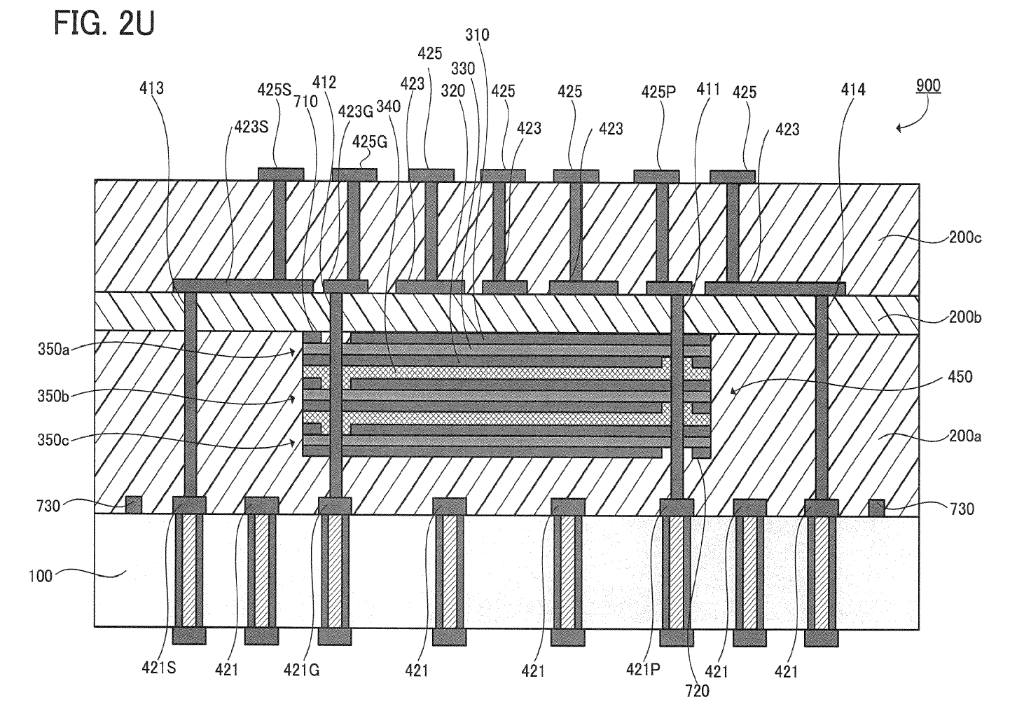

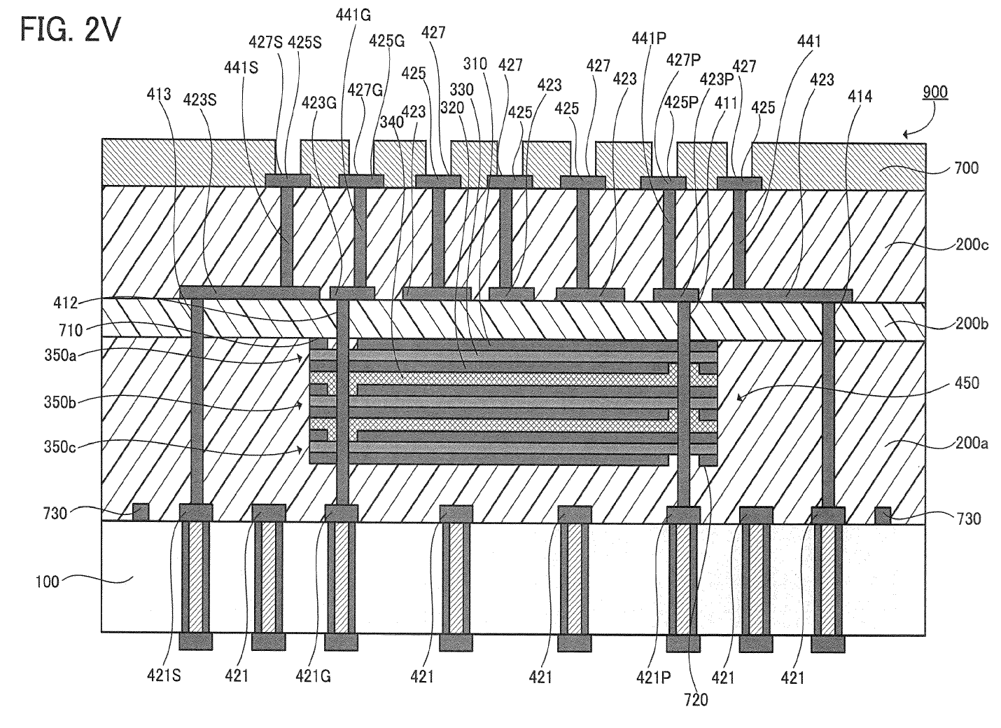

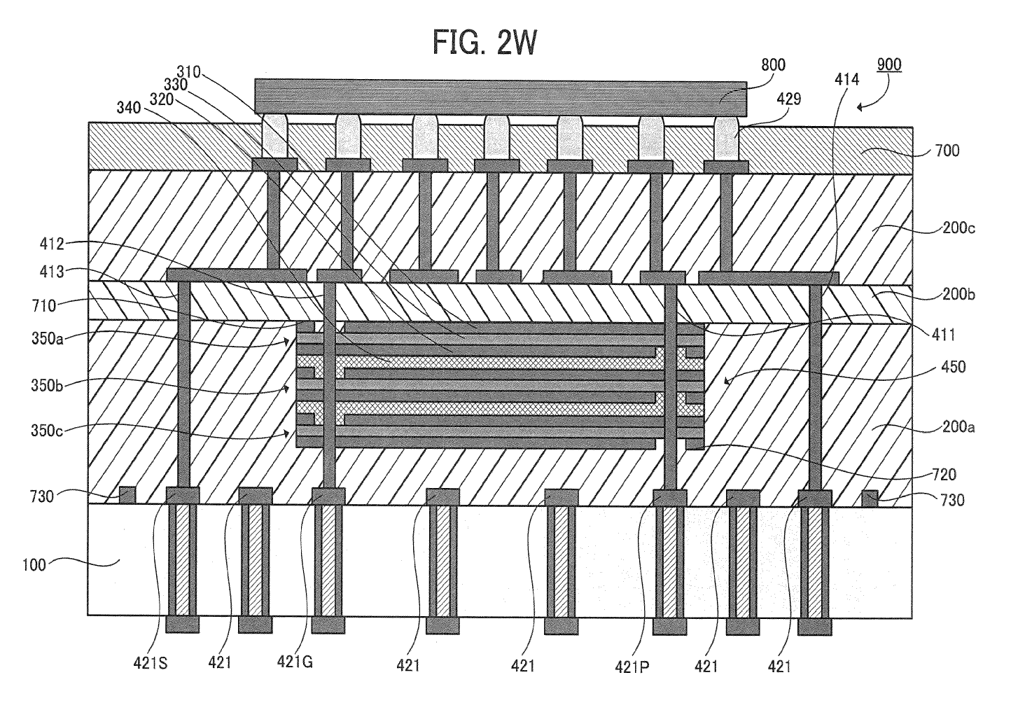

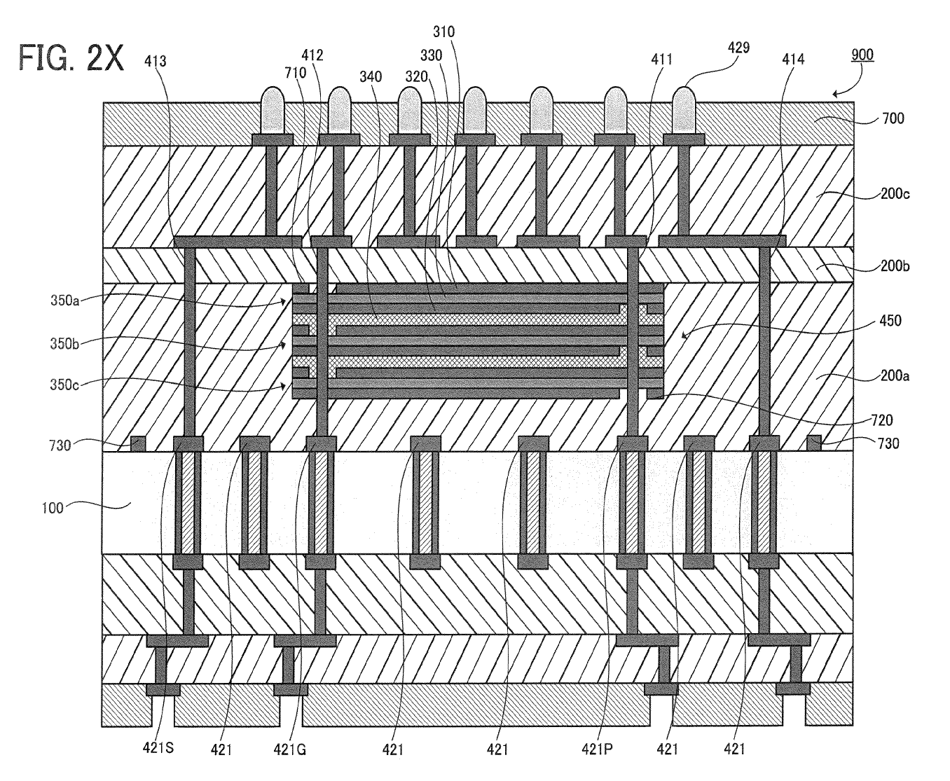

Next, the uncalcined layer is calcined in a vacuum or a non-oxide atmosphere such as N₂ gas or the like at temperatures in the range of 600 to 950° C. to form dielectric layer (330). After that, using vacuum deposition equipment such as sputtering or the like, a metal layer made of copper is formed on dielectric layer (330). Furthermore, copper is added to be approximately 5 μm thick on the metal layer by electrolytic plating or the like. Accordingly, second electrode (320) is formed. Through such a process, as shown in FIG. 2A), a capacitor is obtained in which dielectric layer (330) made of BaTiO₃ is sandwiched by first electrode (310) and second electrode (320), both of which are made of copper.

Next, as shown in FIG. 2B), etching is performed using a copper (II) chloride etching solution to remove portions except for the necessary portions of first electrode (310) and second electrode (320). Accordingly, a single unit of capacitor (350) is formed where first electrode (310) and second electrode (320) are shifted from each other in a direction parallel to their planar surfaces (namely, in a horizontal direction). In such a case, first electrode (310) and second electrode (320) are shifted from each other so that the overlapping area of first electrode (310) and second electrode (320) positioned on top and bottom respectively of dielectric layer (330) is set to be in the range of 0.4 to 1.0 cm². Also, through the etching process, alignment mark (710) is formed in first electrode (310), and alignment mark (720) is formed in second electrode (320).

Next, as shown in FIG. 2C), three capacitors (350a, 350b, 350c) are laminated vertically. When laminating capacitors (350a, 350b, 350c), epoxy resin as an adhesive agent is used between capacitors (350). The single units of capacitors (350a, 350b, 350c) are aligned with each other based on alignment mark (710) or alignment mark (720) formed in each capacitor.

Then, as shown in FIG. 2D), capacitor laminate (450) is obtained in which three capacitors (350a, 350b, 350c) are laminated using adhesive agent (340) between each capacitor.

Next, as shown in FIG. 2E), on base substrate (core substrate) (100) having alignment marks (730), a thermosetting resin film is laminated using a vacuum laminator under lamination conditions of temperature in the range of 50-170° C. and pressure in the range of 0.4-1.5 MPa. On base substrate (100), conductive patterns (421) (421P, 421G, 421S) are formed. The base substrate is a glass-epoxy substrate with a thickness of 0.6 mm. At the time of lamination, the thermosetting resin film is semi-cured; it will become first resin insulation layer (lower-layer resin insulation layer) (200a) when it is cured. As for a resin film, for example, two sheets of “ABF-45SH” made by Ajinomoto Fine-Techno Co., Inc. may be used.

Next, as shown in FIG. 2F), capacitor laminate (450) is aligned and laminated on semi-cured first resin insulation layer (200a). To align them, alignment mark (710) of capacitor (350a) in capacitor laminate (450) and alignment marks (730) on base substrate (100) are recognized by a camera. Alternatively, alignment mark (720) of capacitor (350c) in capacitor laminate (450) and alignment marks (730) on base substrate (100) are recognized by a camera. Only alignment marks (710) or alignment marks (720) may be formed, but both of them may be formed as well.

Then, as shown in FIG. 2G), vacuum pressing is conducted under pressing conditions of 0.4 MPa, 170° C. and two hours, and capacitor laminate (450) is embedded in first resin insulation layer (200a) while curing first resin insulation layer (200a). Capacitor laminate (450) is embedded in first resin insulation layer (200a) so that the upper surface of capacitor laminate (450) is made flush with the upper surface of first resin insulation layer (200a).

Here, as shown in FIG. 2H), the capacitor laminate may be laminated in such a way that capacitor (350c) is partially embedded in first resin insulation layer (200a). In such a case, alignment mark (720) of capacitor (350c) or alignment mark (710) of capacitor (350a) in capacitor laminate (450) and alignment marks (730) on base substrate (100) are used as a guide for aligning capacitor laminate (450) and first resin insulation layer (200a).

Next, as shown in FIG. (2I), on first resin insulation layer (200a) and capacitor laminate (450), a resin film is laminated using a vacuum laminator under lamination conditions of temperature in the range of 50-170° C. and pressure in the range of 0.4-1.5 MPa. For a resin film, for example, an “ABF-45SH” made by Ajinomoto Fine-Techno Co., Inc. may be used. Then, the resin film is cured through a process at 170° C. for two hours, and second resin insulation layer (upper-layer resin insulation layer) (200b) is formed.

Next, as shown in FIG. (2J), using a carbon-dioxide gas laser, through-holes (470) (470P, 470G, 470S) are formed which penetrate second resin insulation layer (200b), first resin insulation layer (200a) and capacitor laminate (450) and reach conductive patterns (421) (power-source conductive pattern (421P), ground conductive pattern (421G), and signal conductive pattern (421S)) on base substrate (100).

Through-holes (470P) are power-source through-holes that reach conductive pattern (421P) for power source. Through-holes (470G) are ground through-holes that reach conductive pattern (421G) for ground. The diameter of through-holes (470) (470P, 470E 470S) is in the range of 20-100 μm. Here, through-holes (470) (470P, 470G, 470S) may be formed using a drill instead of carbon-dioxide gas laser. The positions of through-holes (470) (470P, 470G, 470S) are determined by recognizing through a camera or X-rays either alignment marks (730) of base substrate (100), or alignment mark (710) of capacitor (350a) in capacitor laminate (450), or alignment mark (720) of capacitor (350c) in capacitor laminate (450).

As shown in plan views of FIGS. 2K, 2L), the overlapping area of first electrode (310) and second electrode (320) forms a capacitor. As shown in FIG. (2K), first electrode (310) and second electrode (320) may be shifted only crosswise; however, as shown in FIG. (2L), first electrode (310) and second electrode (320) may also be shifted crosswise as well as longitudinally. The overlapping area of first electrode (310) and second electrode (320) is indicated by diagonal lines. Since first electrode (310) and second electrode (320) are shifted from each other in a direction parallel to their planar surfaces, there is an area where they do not overlap. In the area not overlapping, through-holes (470P, 470G) are formed. As such, since through-holes (470P, 470G) are not formed in the area where first electrode (310) and second electrode (320) face each other, the area where first electrode (310) faces second electrode (320) may be increased. Power-source through-holes (470P) touch first electrode (310) (power-source electrode), but they do not touch second electrode (320) (ground electrode). Ground through-holes (470G) touch second electrode (320), but they do not touch first electrode (310).

As shown in FIG. (2J), other than through-holes (470P, 470G), signal through-holes (470S) are formed so as to reach the signal conductive pattern. Signal through-holes (470S) are formed in the area where capacitor laminate (450) does not exist.

Next, on the surface of second resin insulation layer (200b) and on the inner walls of through-holes (470S, 470P, 470E 470) (especially on conductive circuits such as conductive patterns (421S, 421P, 421G, 421) and electrodes of capacitor laminate (450)), a dry desmear treatment is conducted. For such a desmear treatment, dry etching (for example, plasma etching, reactive ion etching or the like) with a reaction gas of O₂ and CF₄ is conducted using, for example, dry desmear equipment made by Kyushu Matsushita. By mixing CF₄ in the reaction gas, glass filler contained in the resin insulation layers may be removed more easily. As for a gas used in dry etching, other than a mixed gas of O₂ and CF₄, an Ar gas or O₂ gas may also be used.

Next, on the surface of second resin insulation layer (200b) and on the inner walls of through-holes (470S, 470P, 470E 470), seed metal (such as copper) is formed through dry processing. In the seed metal forming process, for example, using inline sputtering equipment made by Canon Anelva Corporation, a nickel (Ni) layer with a thickness of 0.1 μm is formed by sputtering, then a copper (Cu) layer with a thickness of 0.5 μm is further laminated thereon to form a two-layer seed metal. Here, any sputtering equipment, for example, magnetron sputtering equipment, triode sputtering equipment, ion-beam sputtering equipment or the like may be used. Also, as for a dry process, other than the above sputtering methods, the following may also be employed: CVDs such as atmospheric pressure CVD, low-pressure CVD, plasma excitation CVD, photoexcitation CVD or the like; and except for sputtering, PVDs such as vacuum deposition, ion plating or the like.

Next, using the above seed metal, on the surface of second resin insulation layer (200b) and on the inner walls of through-holes (470S, 470P, 470G, 470), electroless plated film (electroless copper-plated film) is formed. Then, on the electroless plated film, electrolytic plated film (electrolytic copper-plated film) is formed. Electrolytic plated film may also be formed on the sputtered film. In the following, etching resist is formed on the electrolytic plated film. Then, after being exposed and developed, etching resist is patterned. Here, a photolithography process, in which the areas on the resin layer to form a pattern and the areas to protect the through-hole plating are covered with resist, is called a tenting method. Then, by etching away the electrolytic plated film and electroless plated film from the areas where etching resist is not formed, conductive patterns (423) (power-source conductive pattern (423P), ground conductive pattern (423G), signal conductive pattern (423S)) and via conductors (411, 412, 413) are formed as shown in FIG. 2M).

To form via conductors (411, 412, 413), a method may be employed in which copper-plated film is formed after a wet desmear treatment. For example, as shown in FIG. (2N), through-holes (1006) are formed by a carbon-dioxide gas laser in insulation layer (1001) and capacitor (1005) to electrically connect capacitor (1005) and conductive pattern (1000) in insulation layer (1001). Capacitor (1005) is formed with the following: first electrode (1004) (upper electrode) made of copper; second electrode (1002) (lower electrode) made of nickel; and dielectric layer (1003) made of a film with a high relative dielectric constant (high k) such as BST or the like. Then, after a wet desmear treatment is conducted using a treatment solution such as a KMnO₄ solution, copper-plated film (1007) is formed. In doing so, first electrode (1004) of capacitor (1005) and conductive pattern (1000) may be electrically connected. However, in such a case, as the photographs show in FIG. (2O), due to the desmear treatment, gaps may occur between dielectric layer (1003) and insulation layer (1001), or dielectric layer (1003) may peel (lift off) from insulation layer (1001). In such a case, during a plating process in the later step, there is a risk that plating may be deposited between dielectric layer (1003) and insulation layer (1001), causing first electrode (1004) and second electrode (1002) to be short-circuited. Contrary to such a case, in the present embodiment, after a dry desmear treatment, seed metal is formed through dry processing (for example, sputtering), then copper-plated film is further formed thereon. Thus, damage to dielectric layer (1003) is reduced, and short-circuiting between capacitor electrodes is suppressed. Accordingly, excellent electrical characteristics may be achieved.

FIGS. (2P, 2Q) show an example of a capacitor device manufactured by the first method (wet desmear treatment), and FIGS. (2R, 2S) show an example of a capacitor device manufactured by the latter method (dry desmear treatment). As it is clear from comparing the photographs in FIGS. (2Q) and (2S), damage to dielectric layer (1003) (BST) is less in the latter method than in the first method, and thus short-circuiting between capacitor electrodes (Cu—Ni) is suppressed.

Via conductors (411) are power-source via conductors, and as shown in FIG. (2M), they electrically connect first electrodes (310) of capacitors (350a, 350b, 350c) with each other. Via conductors (412) are ground via conductors, and as shown in FIG. (2M), they electrically connect second electrodes (310) of capacitors (350a, 350b, 350c) with each other.

Power-source via conductors (411) connect power-source conductive pattern (421P) on base substrate (100) and power-source conductive pattern (423P) on second resin insulation layer (200b). Also, ground via conductors (412) connect ground conductive pattern (421G) on base substrate (100) and ground conductive pattern (423G) on second resin insulation layer (200b).

Next, as shown in FIG. (2T), on second resin insulation layer (200b) and conductive patterns (423) (423P, 423G, 423S), third resin insulation layer (200c) is formed. The material of third resin insulation layer (200c) is the same as that of second resin insulation layer (200b) and first resin insulation layer (200a).

Next, in third resin insulation layer (200c), through-holes are formed using a carbon-dioxide gas laser. Here, through-holes may also be formed using a drill.

Next, the surface of third resin insulation layer (200c) is treated using a catalyst. After the surface treatment with a catalyst, electroless plated film is formed on the substrate surface. Then, a plating resist is formed on the electroless plated film. In the following, the plating resist is exposed to light and developed to pattern the plating resist. Then, in the region where the plating resist is not formed, electrolytic plated film is formed. After removing the plating resist, the electroless plated film between electrolytic plated films is removed. Accordingly, as shown in FIG. (2U), outermost conductive patterns (425) are formed (outermost power-source conductive pattern (425P), outermost ground conductive pattern (425G), outermost signal conductive pattern (425S)), which are made up of electroless plated film and electrolytic plated film on the electroless plated film.

Next, solder resist (700) is formed on third resin insulation layer (200c) and outermost conductive patterns (425) (425P, 425G, 425S). After that, as shown in FIG. (2V), by forming opening portions in solder resist (700) so as to partially expose conductive patterns (425) (425P, 425G, 425S), pads (427) are formed (power-source pads (first external terminals) (427P), ground pads (second external terminals) (427G), signal pads (427S)). The portions exposed through the opening portions become pads (427) (427P, 427G, 427S).

As shown in FIG. (2V), first electrodes (310) and power-source pads (427P) are connected through via conductors (411), conductive pattern (423P) and via conductors (441P). Also, second electrodes (320) and ground pads (427G) are connected through via conductors (412), conductive pattern (423G) and via conductors (441G).

Next, erosion-resistant metal film is formed on pads (427) (427P, 427E 427S). As for such metal film, a film made of, for example, Ni, Au, Pd, Ag, Pt or the like may be formed. In the present embodiment, Ni film, Pd film and Au film are formed in that order. Here, a single-layer metal film may be formed, but a multilayer film may also be formed. For example, Ni film and Au film may be formed on a pad in that order.

Next, solder paste is printed on the metal film. Then, through a reflow process, solder bumps (429) are formed. Accordingly, wiring board (900) is obtained as shown in FIG. 1).

Then, when mounting IC chip (800), IC chip (800) is mounted through solder bumps (429) as shown in FIG. 2W).

In the present embodiment, resin insulation layers, conductive patterns and via conductors are formed only on one side of base substrate (100). However, as shown in FIG. (2X), resin insulation layers, conductive patterns and via conductors may also be formed on both surfaces of base substrate (100).

In addition, the surfaces of resin insulation layers (200a, 200b, 200c), the surfaces of conductive patterns, the surfaces of first electrodes (310), and the surfaces of second electrodes (320) are preferred to be roughened. Also, when mounting IC chip (800) on the surface of wiring board (900), it is preferred that the distance between capacitor laminate (450) and IC chip (800) be short.

### (Second Embodiment of a Wiring Board According to the Present Invention)

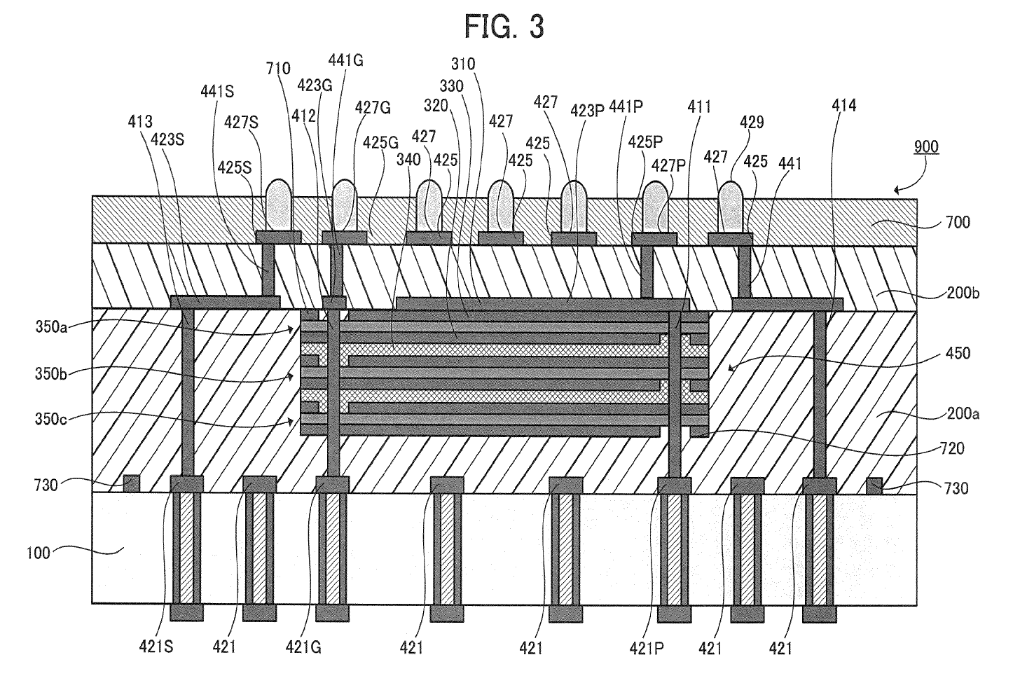

In the First Embodiment, resin insulation layers (200) were made up of first resin insulation layer (200a), second resin insulation layer (200b) and third resin insulation layer (200c). In wiring board (900) according to the Second Embodiment, as shown in FIG. 3), resin insulation layers (200) are different from those in the First Embodiment, and are made up of first resin insulation layer (200a) and second resin insulation layer (200b).

Also, the electrode positioned at the uppermost layer of capacitor laminate (450) is formed by integrating first electrode (310) of capacitor (350a) and power-source conductive pattern (423P) on that first electrode (310). Therefore, in wiring board (900) according to the Second Embodiment, the thickness of the electrode positioned at the surface layer of capacitor laminate (450) is greater than that in wiring board (900) of the First Embodiment. Therefore, the rigidity of capacitor laminate (450) increases, and cracks seldom occur in the dielectric layers of capacitor laminate (450).

As shown in FIG. 3), power-source pads (first external terminals) (427P) and first electrodes (310) of capacitors (350a, 350b, 350c) are electrically connected through via conductors (441P), conductive pattern (423P) and via conductors (411). Ground pads (second external terminals) (427G) and second electrodes (320) of capacitors (350a, 350b, 350c) are electrically connected through via conductors (441G), conductive pattern (423G) and via conductors (412).

On second resin insulation layer (200b), outermost power-source conductive pattern (425P), outermost ground conductive pattern (425G) and outermost signal conductive pattern (425S) are formed.

In solder resist (700), opening portions are formed to partially expose conductive patterns (425) (425P, 425E 425S), and pads (427) are formed (power-source pads (first external terminals) (427P), ground pads (second external terminals) (427G), signal pads (427S)).

### (A Method of Manufacturing a Wiring Board According to the Second Embodiment of the Present Invention)

Next, another method of manufacturing a wiring board is shown according to the Second Embodiment.

First, from FIG. (2A) to FIG. (2G), the method of manufacturing a wiring board is the same as above.

Next, in the substrate formed in the steps through FIG. (2G), as shown in FIG. (4A), through-holes (470) are formed (through-holes (470P) reaching the power-source conductive pattern on the core substrate, through-holes (470G) reaching the ground conductive pattern on the core substrate, through-holes (470S) reaching the signal conductive pattern on the core substrate). In the manufacturing method according to the First Embodiment, at the same time, through-holes are also formed in second resin insulation layer (200b). However, in the manufacturing method according to the present embodiment, through-holes are formed only to penetrate capacitor laminate (450) and first resin insulation layer (200a). Therefore, the hole processing is easier and productivity increases.

Next, a dry desmear treatment is conducted on the inner-wall surfaces of through-holes (470S, 470P, 470G, 470), especially on conductive circuits such as conductive patterns (421S, 421P, 421G, 421) and the electrodes of capacitor laminate (450).

Next, seed metal (such as copper) is formed through dry processing on the inner-wall surfaces of through-holes (470S, 470P, 470G, 470). Then, using the seed metal, electrolytic plated film is formed on the seed metal. Thus, through-holes are filled with electrolytic plated film. At the same time, the electrolytic plated film is also formed on insulation layer (200a) and on the capacitor laminate.

Next, as shown in FIG. (4B), using a tenting method, ground via conductors (412), power-source via conductors (411), signal via conductor (413) and conductive patterns (423) (power-source conductive pattern (423P), ground conductive pattern (423G), signal conductive pattern (423S)) are formed.

As shown in FIG. (4B), the electrode positioned at the uppermost layer of capacitor laminate (450) is formed by integrating first electrode (310) of capacitor (350a) and power-source conductive pattern (423P) on that first electrode (310). Here, the electrode positioned at the uppermost layer of capacitor laminate (450) indicates the electrode on the surface of capacitor laminate (450) closer to where IC chip (800) will be mounted. Also, power-source conductive pattern (423P) on first electrode (310) is made up of electroless plated film and electrolytic plated film on the electroless plated film.

Via conductors (412) connect second electrodes (320) of capacitors (350a, 350b, 350c) with each other. Also, via conductors (412) connect ground conductive pattern (421G) on base substrate (100) and ground conductive pattern (423G) on first resin insulation layer (200a).

Via conductors (411) connect first electrodes (310) of capacitors (350a, 350b, 350c) with each other. Also, via conductors (411) connect power-source conductive pattern (421P) on base substrate (100) and power-source conductive pattern (423P) on first resin insulation layer (200a).

Next, as shown in FIG. (4C), second insulation layer (200b) is formed on first resin insulation layer (200a), capacitor laminate (450) and conductive patterns (423) (423P, 423G, 423S). Then, through-holes are formed in second resin insulation layer (200b). Then, using a catalyst, a surface treatment is conducted on the surface of the substrate where through-holes are formed.

After the surface treatment with a catalyst, electroless plated film is formed on the surface of the substrate. After that, a plating resist is formed on the electroless plated film. Then, the plating resist is exposed to light and developed to pattern the plating resist. Then, electrolytic plated film is formed on the region where the plating resist is not formed. After the plating resist is removed, the electroless plated film between portions of the electrolytic plated film is removed to form conductive patterns (425) (425P, 425G, 425S) which are made up of electroless plated film and electrolytic plated film on the electroless plated film. In the following, as in the First Embodiment, solder resist (700), pads (427) and solder bumps (429) are formed. Accordingly, wiring board (900) shown in FIG. (3) is obtained.

According to the manufacturing method of the present embodiment, a wiring board may be manufactured with one fewer resin insulation layer than those of the First Embodiment. Thus, wiring board (900) may be manufactured at a lower cost.

In the above embodiment, resin insulation layers, conductive patterns and via conductors are formed only on one side of base substrate (100). However, as shown in FIG. (4D), resin insulation layers, conductive patterns and via conductors may also be formed on both surfaces of base substrate (100).

### (Third Embodiment of a Wiring Board According to the Present Invention)

FIG. (5) shows the Third Embodiment of the present invention. The Third Embodiment is different from the First Embodiment in that first electrode (310) and second electrode (320) are not shifted from each other in a direction parallel to their planar surfaces. Multiple first opening portions (311) are formed in first electrodes (310) and multiple second opening portions (322) are formed in second electrodes (320).

Then, multiple first via conductors (411) electrically connect first electrodes (310) with each other while penetrating through second opening portions (322) without touching second electrodes (320). Also, multiple second via conductors (412) electrically connect second electrodes (320) with each other while penetrating through first opening portions (311) without touching first electrodes (310).

As such, multiple first via conductors (411) and multiple second via conductors (412) penetrate capacitor laminate (450). Therefore, in wiring board (900) according to the Third Embodiment, multiple first via conductors (411) and multiple second via conductors (412) may keep adhesive layers (340) from becoming deformed, allowing capacitor laminate (450) to improve its resistance to cracking.

Namely, if the thermal expansion coefficient of dielectric layer (330) of each capacitor (350a, 350b, 350c) and that of adhesive layer (340) bonding each capacitor (350a, 350b, 350c) are different, stresses such as warping, twisting, bending or the like are exerted on dielectric layers (330) when temperatures change around capacitor laminate (450). When such stresses are exerted, since dielectric layers (330) made of ceramics are thin and fragile, cracks may easily occur. However, in the present embodiment, multiple first via conductors (411) and multiple second via conductors (412) penetrate capacitor laminate (450), physically bonding capacitors (350a, 350b, 350c) with each other. Thus, it is possible to keep adhesive layers (340) from becoming deformed. Accordingly, stresses such as warping, twisting, bending or the like exerted on dielectric layers (330) may be reduced.

As shown in FIGS. (6A, 6B), power-source via conductors (411) and ground via conductors (412) are preferred to be configured either in a grid or a zigzag pattern. Distances between adjacent power-source via conductors (411) are substantially the same, and distances between adjacent ground via conductors (412) are substantially the same.

### (A Method of Manufacturing a Wiring Board According to the Third Embodiment of the Present Invention)

First, as shown in FIG. (7A), capacitor (350) is made up of first electrode (310) and second electrode (320) with dielectric layer (330) sandwiched between first electrode (310) and second electrode (320). Capacitor (350) is formed the same as in the First Embodiment.

Next, first electrode (310) and second electrode (320) are patterned as shown in FIG. (7B), also as in FIG. (7C) which shows a plan view of capacitor (350) seen from the side of first electrode (310), and in FIG. (7D) which shows a plan view of capacitor (350) seen from the side of second electrode (320). At the same time, alignment marks (710, 720) are formed.

Opening portions (311) are formed in first electrode (310), and ground via conductors (412) will be formed in opening portions (311). First electrode (310) and ground via conductors (412) do not touch each other. In second electrode (320), opening portions (322) are formed and power-source via conductors (411) will be formed in opening portions (322). Second electrode (320) and power-source via conductors (411) do not touch each other.

Next, as shown in FIG. (7E), three sets of capacitors (350) obtained in the earlier steps are prepared and are laminated using adhesive agent (340) between them. Capacitors (350a, 350b, 350c) are aligned based on alignment marks (710, 720) of each capacitor (350).

Next, as shown in FIG. (7F), capacitor laminate (450) is formed with capacitors (350a, 350b, 350c) and adhesive agent (340) used between each capacitor. Capacitor laminate (450) is formed by means of vacuum pressing under vacuum pressing conditions of temperature in the range of 50 to 170° C. and pressure in the range of 0.4 to 1.5 MPa.

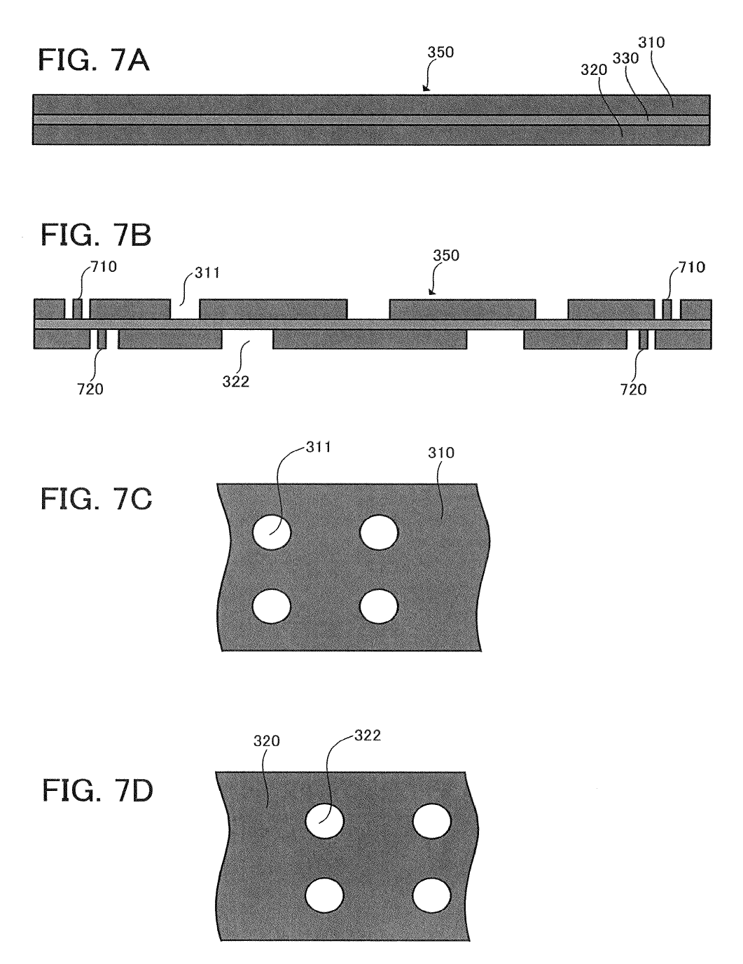

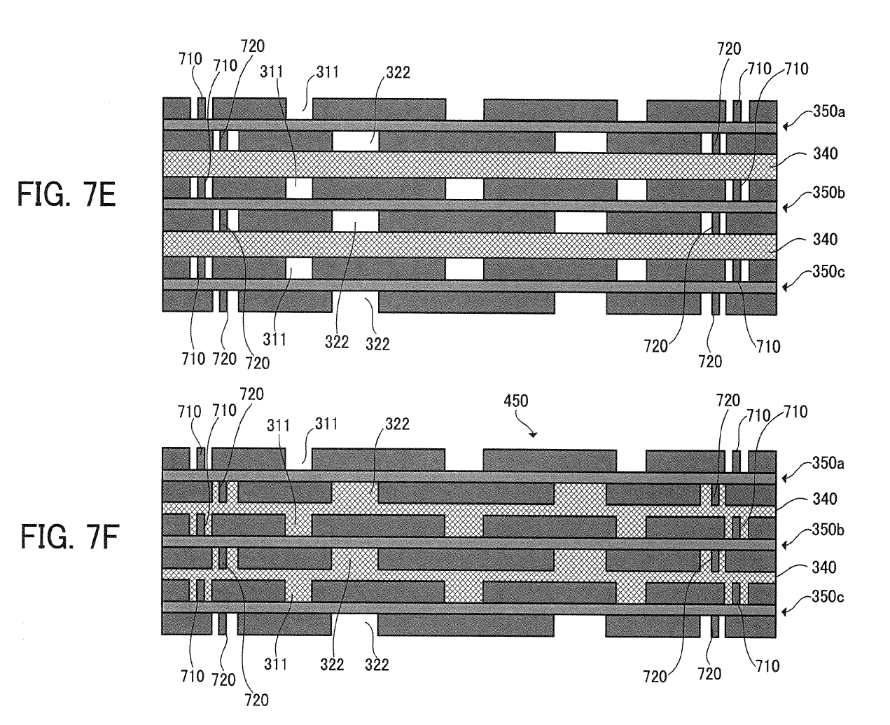

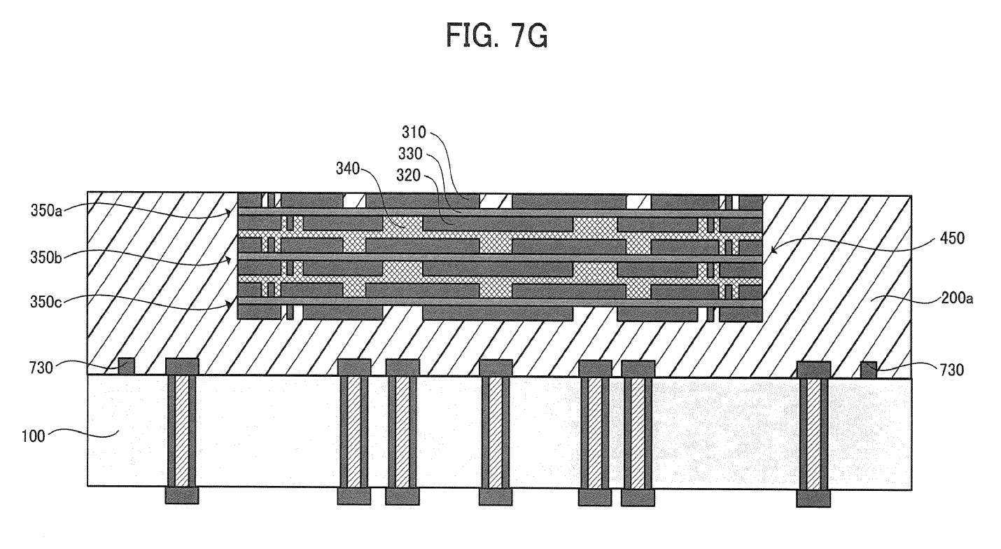

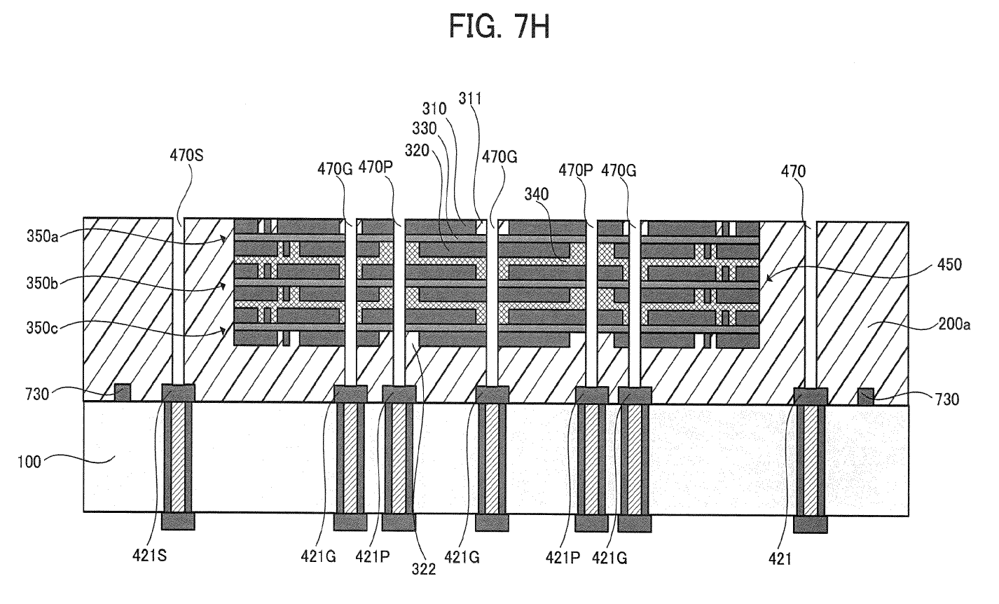

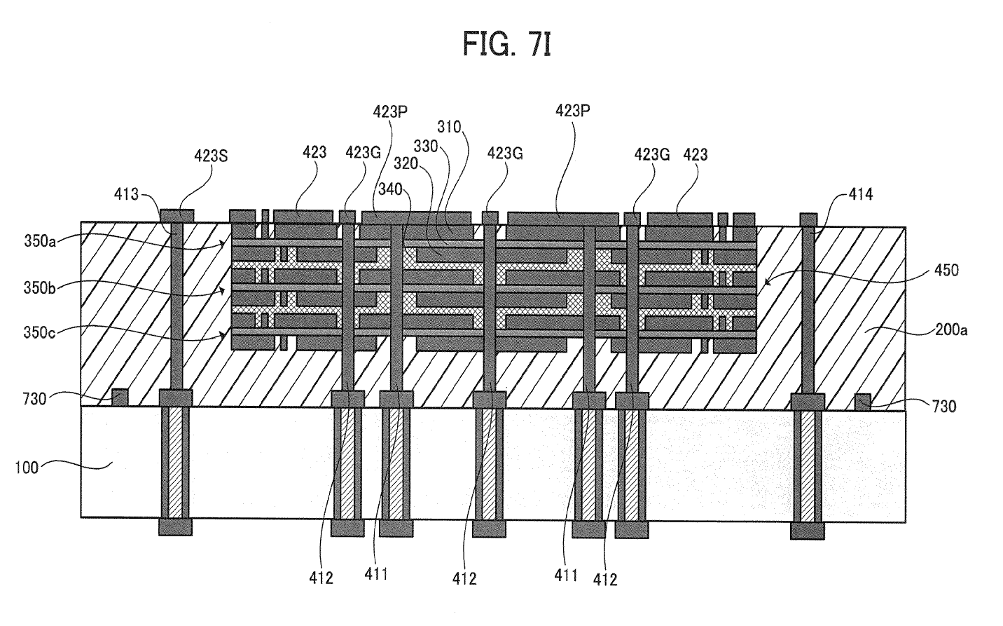

Opening portions (311) of each capacitor that forms capacitor laminate (450) are arranged in substantially the same vertical direction so that first electrode (310) and second electrode (320) will not be short-circuited by via conductors (412) penetrating capacitor laminate (450). Namely, as shown in FIG. 7F), opening portions (311) formed in capacitors (350a, 350b, 350c) are arranged in vertically overlapping positions.

Opening portions (322) of each capacitor that forms capacitor laminate (450) are arranged in substantially the same vertical direction so that first electrode (310) and second electrode (320) will not be short-circuited by via conductors (411) penetrating capacitor laminate (450). Namely, as shown in FIG. (7F), opening portions (322) formed in capacitors (350a, 350b, 350c) are arranged in vertically overlapping positions.

Next, as shown in FIG. (7G), capacitor laminate (450) is embedded in first resin insulation layer (200a).

Next, as shown in FIG. (7H), through-holes (470) (470P, 470G, 470S) are formed. Through-holes (470) (470P, 470G, 470S) penetrate capacitor laminate (450) and first resin insulation layer (200a), then reach conductive patterns (421) (421P, 421G, 421S) on base substrate (100). Through-holes (470) (470P, 470G, 470S) are formed through laser processing based on either alignment marks (730) on base substrate (100) or alignment marks (710, 720) formed in capacitor laminate (450).

Power-source through-holes (470P) penetrate first electrodes (310) and dielectric layers (330). In addition, power-source through-holes (470P) are formed in opening portions (322) of second electrodes (320) without touching the inner walls of opening portions (322).

Ground through-holes (470G) penetrate second electrodes (320) and dielectric layers (330). In addition, ground through-holes (470G) are formed in opening portions (311) of first electrodes (310) without touching the inner walls of opening portions (311).

Next, a dry desmear treatment is conducted on the inner-wall surfaces of through-holes (470S, 470P, 470E 470), especially on the conductive circuits such as conductive patterns (421S, 421P, 421G, 421) and the electrodes of capacitor laminate (450).

Next, on the inner-wall surfaces of through-holes (470S, 470P, 470G, 470), seed metal (such as copper) is formed through dry processing. Then, using the seed metal, electrolytic plated film is formed on the seed metal. Thus, the through-holes are filled with electrolytic plated film. At the same time, the electrolytic plated film is formed on insulation layer (200a) and the capacitor laminate.

Next, as shown in FIG. (7I), the following are formed by a tenting method: ground via conductors (412), power-source via conductors (411), signal via conductors (413) and conductive patterns (423) (power-source conductive pattern (423P), ground conductive pattern (423G), signal conductive pattern (423S)). Conductive patterns (423) (power-source conductive pattern (423P), ground conductive pattern (423G), signal conductive pattern (423S)) are each made up of electroless plated film and electrolytic plated film on the electroless plated film.

The uppermost-layer electrode of capacitor laminate (450) is formed by integrating first electrode (310) of capacitor (350a) and power-source conductive pattern (423P) (electroless plated film on first electrode (310) and electrolytic plated film on the electroless plated film). The uppermost-layer electrode of capacitor laminate (450) indicates the electrode on the surface layer of capacitor laminate (450) positioned on the side closer to where an IC chip will be mounted.

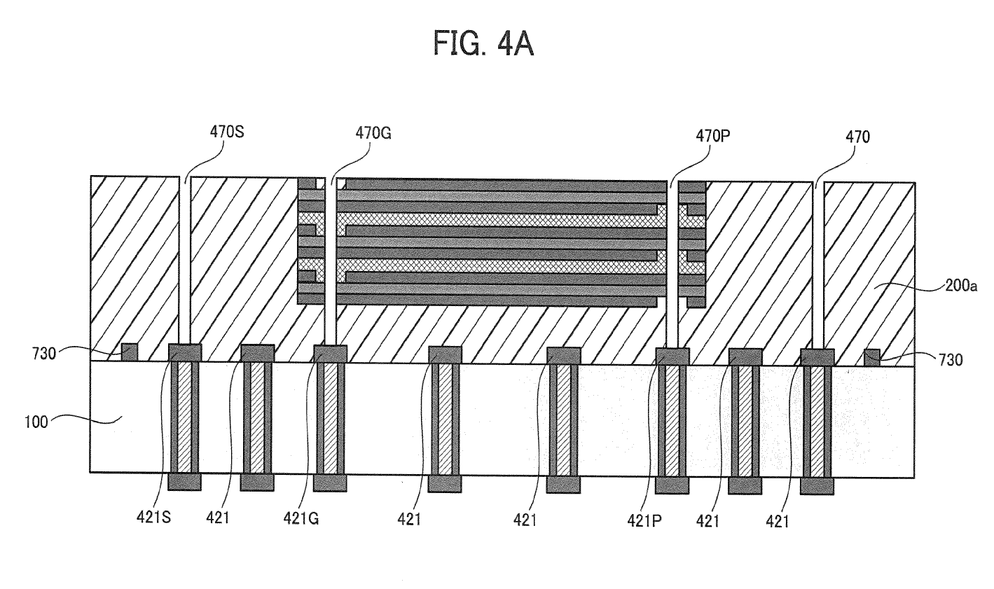

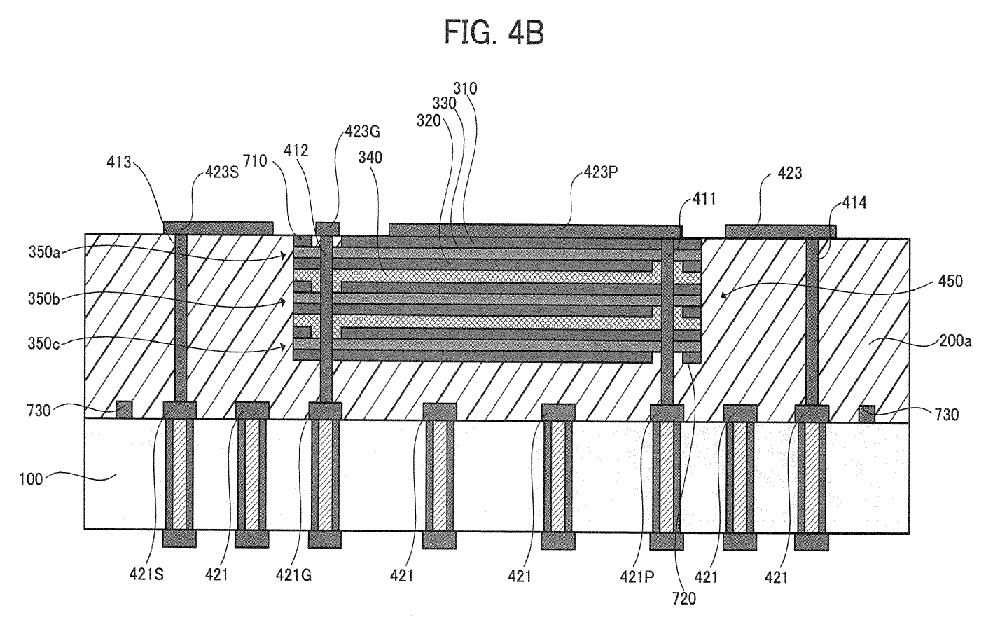

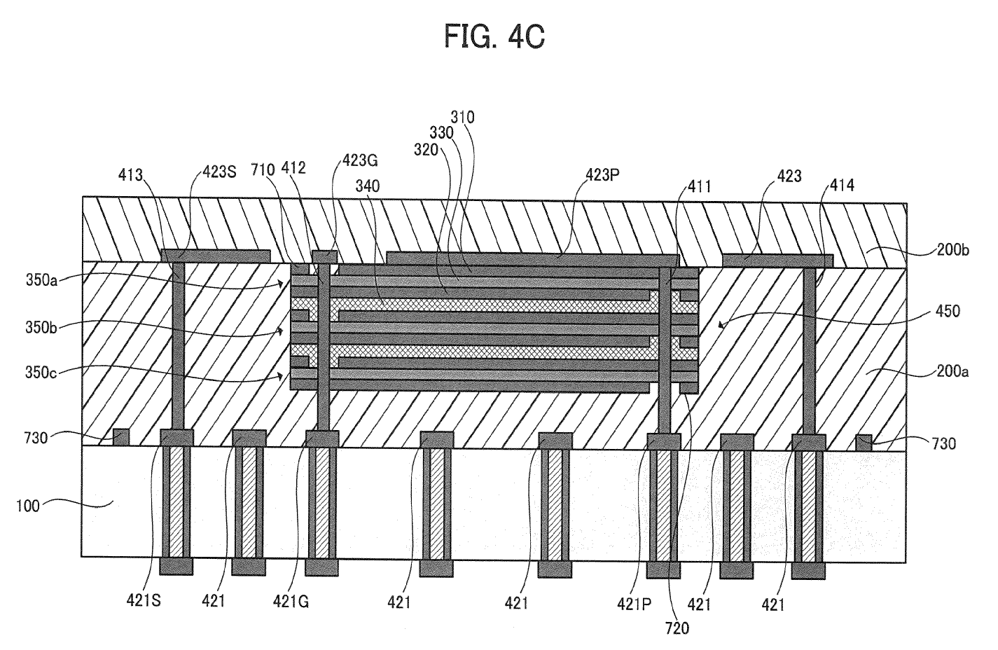

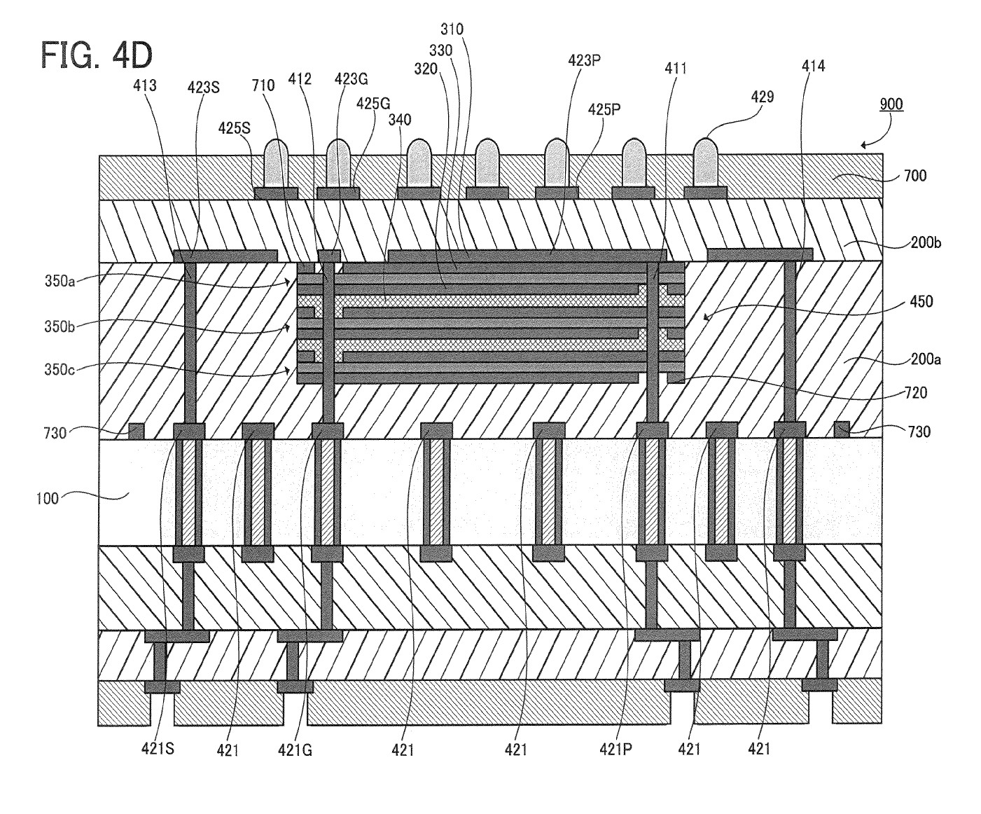

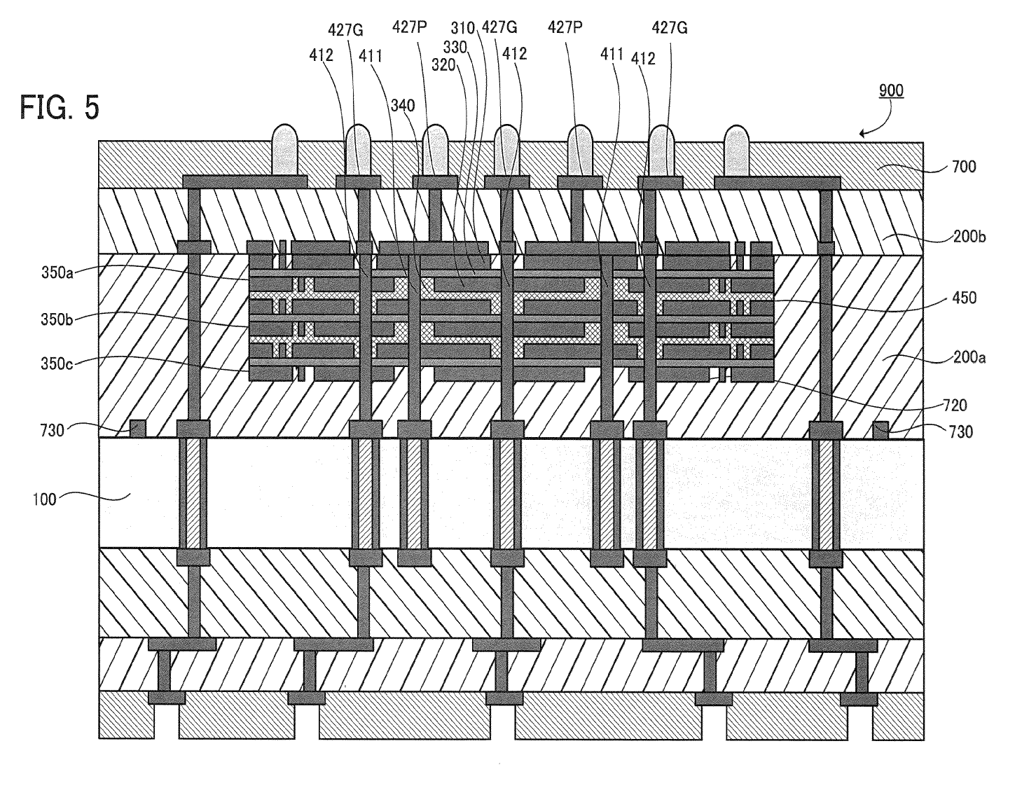

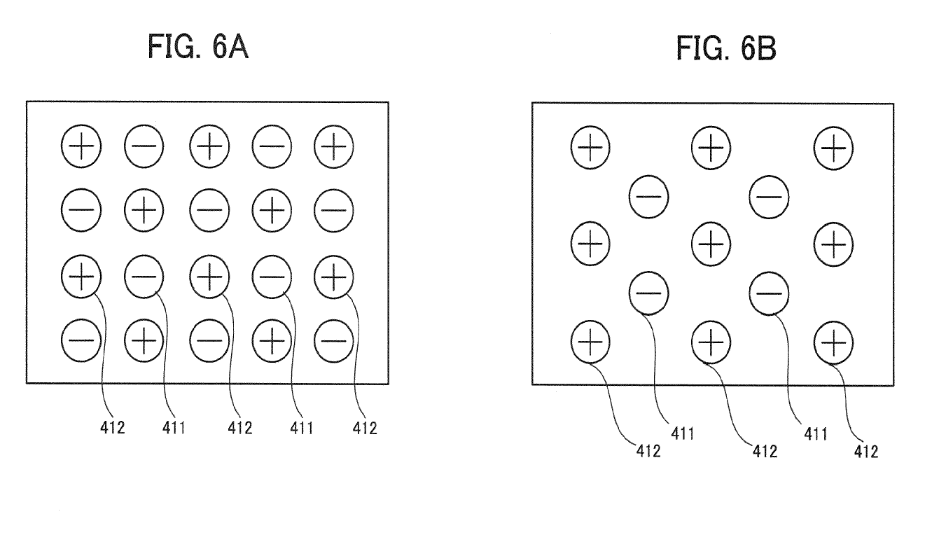

Next, after via conductors and conductive patterns are formed, through the process shown in FIGS. (4C, 4D), a wiring board is obtained as shown in FIG. 5).

### (Fourth Embodiment of a Wiring Board According to the Present Invention)

Wiring board (900) according to the Fourth Embodiment of the present invention is shown in FIG. (8). Wiring board (900) according to the Fourth Embodiment is different from wiring board (900) of the First Embodiment in that it does not have base substrate (core substrate) (100) formed with a core material such as glass cloth or glass fabric. Thus, all the insulation layers may be formed with resin insulation layers (resin films). Accordingly, the board with a built-in capacitor may be made thinner. According to wiring board (900) of the Fourth Embodiment, the distance between an external power source and capacitor laminate (450) built into the wiring board, and the distance between a chip capacitor (omitted from the drawing) mounted on the surface of wiring board (900) and capacitor laminate (450), may be reduced.

### (A Method of Manufacturing a Wiring Board According to the Fourth Embodiment of the Present Invention)

First, as shown in FIG. (9A), support plate (150) is prepared. Support plate (150) is, for example, a copper plate. Here, other than a copper plate, a nickel plate, aluminum plate, iron plate or the like may be used as the material for support plate (150).

Next, as shown in FIG. (9B), plating resist (160) is formed on support plate (150).

Next, as shown in FIG. (9C), plating resist (160) is patterned through an exposure and development process. Accordingly, multiple opening portions are formed in plating resist (160).

Next, as shown in FIG. (9D), gold-plated film (911), nickel-plated film (912) and copper-plated film (913) in that order are formed in the opening portions of plating resist (160) through electrolytic plating. Accordingly, first external connection terminals (600) are formed (power-source external terminals (first external terminals) (600P), ground external terminals (second external terminals) (600G), signal external terminals (600S)). At the same time, alignment marks (first alignment marks)(621) are formed on support plate (150). Here, palladium film may be formed between gold-plated film (911) and nickel-plated film (912).

Next, as shown in FIG. (9E), plating resist (160) is removed and resin film (first lower resin insulation layer) (400d) is formed. First lower resin insulation layer (lowermost resin insulation layer) (400d) is positioned underneath first resin insulation layer (400a) in which capacitor laminate (450) is built, as shown in FIG. (8). As shown in FIG. (9E), first external connection terminals (600) (600P, 600G, 600S) are embedded in the lowermost resin insulation layer (first lower resin insulation layer) having a first surface and a second surface opposite the first surface. Also, the surfaces of first external connection terminals (600) are positioned at substantially the same level as the first surface of the lowermost resin insulation layer.

Next, as shown in FIG. (9F), through-holes are formed in first lower resin insulation layer (400d) to reach first external connection terminals (600) (600P, 6000, 600S).

Next, as shown in FIG. (9G), using a semi-additive method, first conductive patterns (610) (first power-source conductive pattern (610P), first ground conductive pattern (610G), first signal conductive pattern (610S)) are formed on the top surface of first lower resin insulation layer (400d) (the surface opposite the surface where external terminals are formed).

At the same time, first via conductors (611) (first power-source via conductors (611P), first ground via conductors (611G), first signal via conductors (611S)) are formed to connect first external connection terminals (600) (600P, 600G, 600S) and first conductive patterns (610) (610P, 610G, 610S). Also formed at the same time are alignment marks (622).

First power-source via conductors (611P) connect power-source external terminals (600P) (first power-source external terminals) on the first-surface side and first power-source conductive pattern (610P). First ground via conductors (611G) (first ground external terminals) connect ground external terminals (600G) on the first-surface side and first ground conductive pattern (610G). First signal via conductors (611S) (first signal external terminals) connect signal external terminals (600S) on the first-surface side and first signal conductive pattern (610S).

Next, as shown in FIG. (9H), on first conductive patterns (610) (610P, 610G, 610S) and first lower resin insulation layer (400d), resin film (first resin insulation layer 400a) is formed, which has a first surface and a second surface opposite the first surface. To form first resin insulation layer (400a), for example, two layers of ABF-45SH made by Ajinomoto Fine-Techno Co., Inc. may be laminated. The first surface of the first resin insulation layer is laminated on the second surface of the first lower resin insulation layer.

Next, as shown in FIG. (9I), capacitor laminate (450) is aligned and laminated on first resin insulation layer (400a). The position for capacitor laminate (450) to be laminated may be determined using, for example, second alignment marks (622) formed on first resin insulation layer (400a) and alignment marks (720) of capacitor laminate (450). Capacitor laminate (450) may be formed using the same process as in the First Embodiment.

Next, as shown in FIG. (9J), capacitor laminate (450) is embedded in first resin insulation layer (400a) on its second-surface side. The surface of capacitor (350a) is positioned substantially at the same level as the second surface of the first resin insulation layer. The process to embed capacitor laminate (450) is the same as the process described with reference to FIG. (2G).

Next, as shown in FIG. (9K), through-holes are formed.

Next, a dry desmear treatment is conducted on the inner-wall surfaces of the through-holes, especially on the conductive circuits such as conductive patterns (610S, 610P, 610G, 610), the electrodes of capacitor laminate (450) and so forth.

Next, on the inner-wall surfaces of through-holes, seed metal (such as copper) is formed through dry processing. Then, using the seed metal, electrolytic plated film is formed on the seed metal to fill the through-holes with the electrolytic plated film. At the same time, electrolytic plated film is formed on insulation layer (400a) and the capacitor laminate.

Next, as shown in FIG. (9L), via conductors (second via conductors) (651) are formed (second power-source via conductors (651P), second ground via conductors (651G), second signal via conductors (651S)). Also formed are second conductive patterns (650) (second power-source conductive pattern (650P), second ground conductive pattern (650G), second signal conductive pattern (650S)).

Second power-source via conductors (651P) connect first electrodes (310) of capacitors (350a, 350b, 350c) of capacitor laminate (450) with each other. Furthermore, via conductors (651P) connect second power-source conductive pattern (650P) and first power-source conductive pattern (610P).

Second ground via conductors (651G) connect second electrodes (320) of capacitors (350a, 350b, 350c) of capacitor laminate (450) with each other. Furthermore, via conductors (651G) connect second ground conductive pattern (650G) and first ground conductive pattern (610G).

Second signal via conductors (651S) connect second signal conductive pattern (650S) and first signal conductive pattern (610S).

First electrode (310) of each capacitor (350a, 350b, 350c) and first external terminals (600P) are electrically connected through first power-source via conductors (611P), conductive pattern (610P) and via conductors (651P). Also, second electrode (320) of each capacitor (350a, 350b, 350c) and second external terminals (600G) are electrically connected through first ground via conductors (611G), conductive pattern (610G) and via conductors (651G).

Next, as shown in FIG. (9M), resin film (second resin insulation layer) (400b) is formed on second conductive pattern (650) (650P, 650G, 650S) and first resin insulation layer (400a).

Next, as shown in FIG. (9N), through-holes are formed in second resin insulation layer (uppermost resin insulation layer) (400b).

Next, as shown in FIG. (9O), third conductive patterns (660) (third power-source conductive pattern (660P), third ground conductive pattern (660G), third signal conductive pattern (660S)) are formed on second resin insulation layer (400b).

At the same time, third via conductors (661) (third power-source via conductors (661P), third ground via conductors (661G), third signal via conductors (661S)) are formed to connect second conductive patterns (650) (650P, 650G, 650S) and third conductive patterns (660) (660P, 660G, 660S).

Third power-source via conductors (661P) connect third power-source conductive pattern (660P) and second power-source conductive pattern (650P). Third ground via conductors (661G) connect third ground conductive pattern (660G) and second ground conductive pattern (650G). Third signal via conductors (661S) connect second signal conductive pattern (650S) and third signal conductive pattern (660S). Forming such connections may be carried out using, for example, a semi-additive method.

Next, as shown in FIG. (9P), solder resist (700) is formed on second resin insulation layer (400b) and third conductive patterns (660) (660P, 660G, 660S).

Next, as shown in FIG. (9Q), multiple opening portions are formed in solder resist (700). Such opening portions make partial openings in third conductive patterns (660) (660P, 660G, 660S). Portions of third conductive patterns (660) (660P, 660G, 660S) exposed through such opening portions become second external connection terminals (670) (670P, 670G, 670S). The second external connection terminals are formed on second resin insulation layer (uppermost resin insulation layer) (400b), and are made up of second power-source external connection terminals (third external terminals) (670P), second ground external connection terminals (fourth external terminals) (670G) and second signal external connection terminals (670P).

Next, on second external connection terminals (670) (670P, 670G, 670S), plating is performed to form nickel-plated film (912), palladium-plated film (914) and gold-plated film (911) in that order, and a three-layer metal film is formed. The metal film may be formed as a single-layer gold-plated film or as a double-layer film of nickel-plated film and gold-plated film on the nickel-plated film.

Next, as shown in FIG. (9R), support plate (150) is etched away using a copper (II) chloride etching solution. During that time, since metal film is formed on second external connection terminals (670) (670P, 670G, 670S) and first external connection terminals (600) (600P, 600G, 600S), support plate (150) may be removed without etching the external connection terminals. By removing support plate (150), the outer surfaces (exposed portions of the metal film) of first external connection terminals (600) will be exposed.

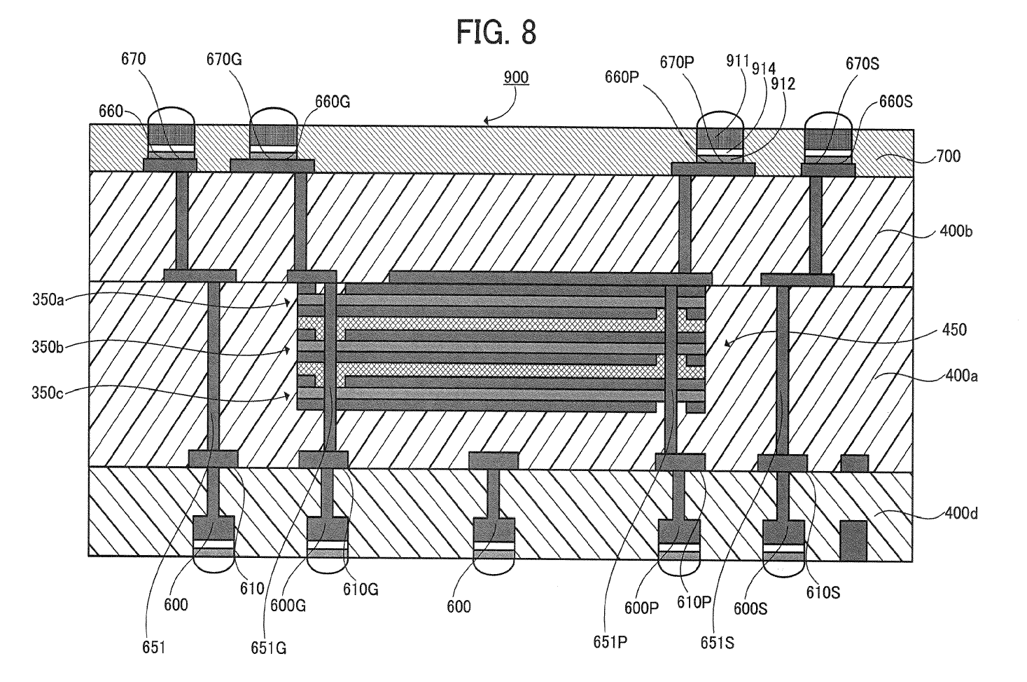

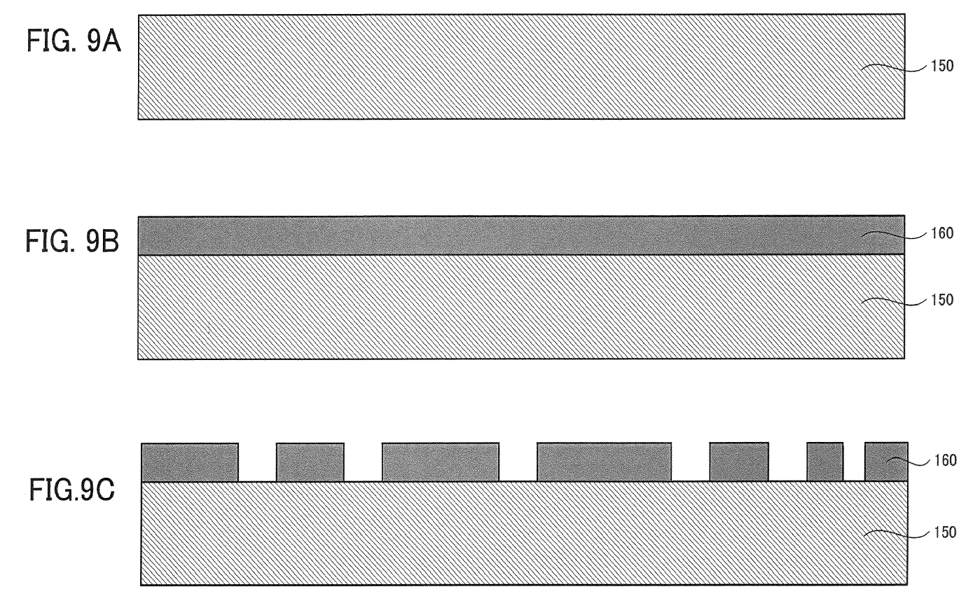

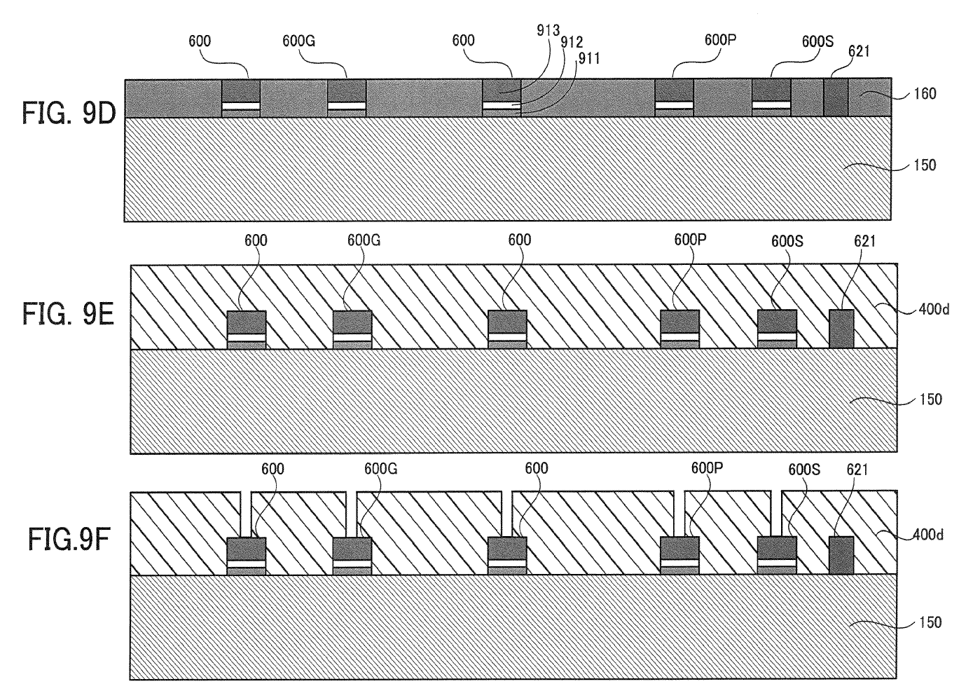

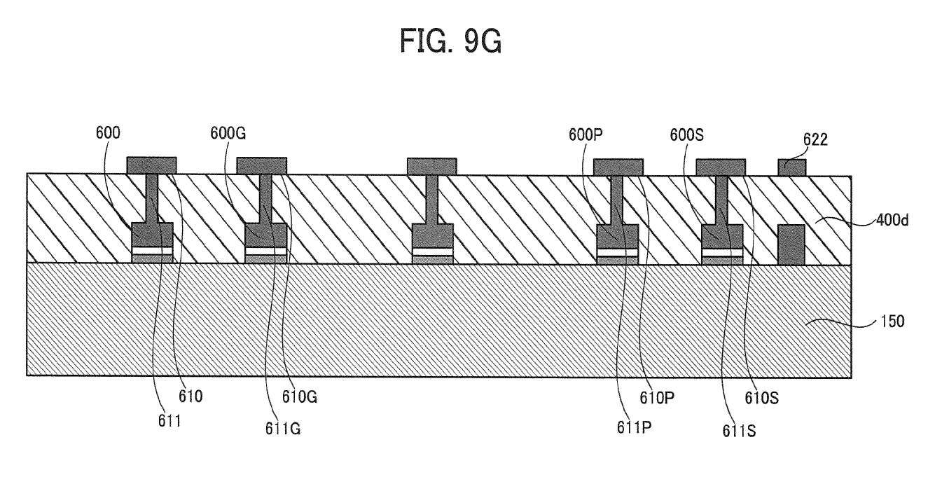

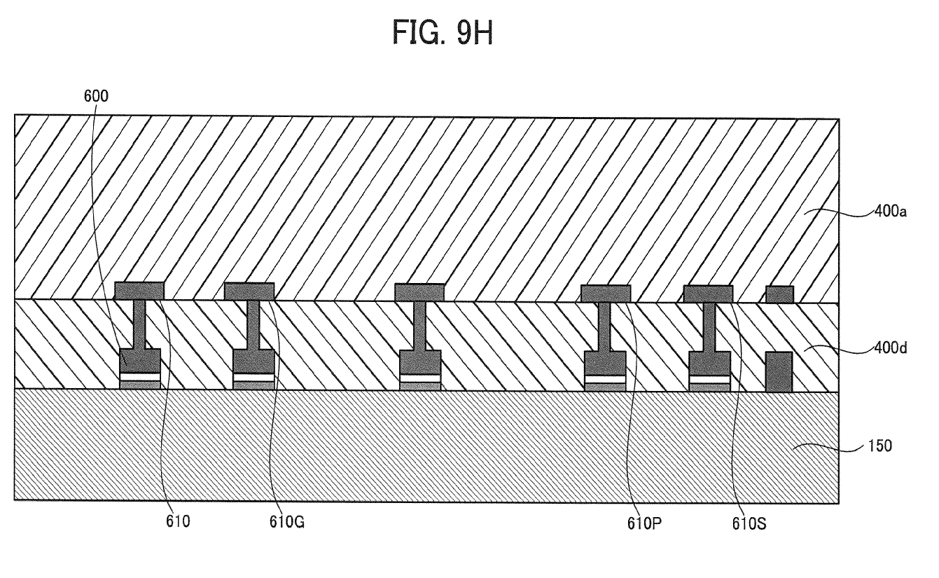

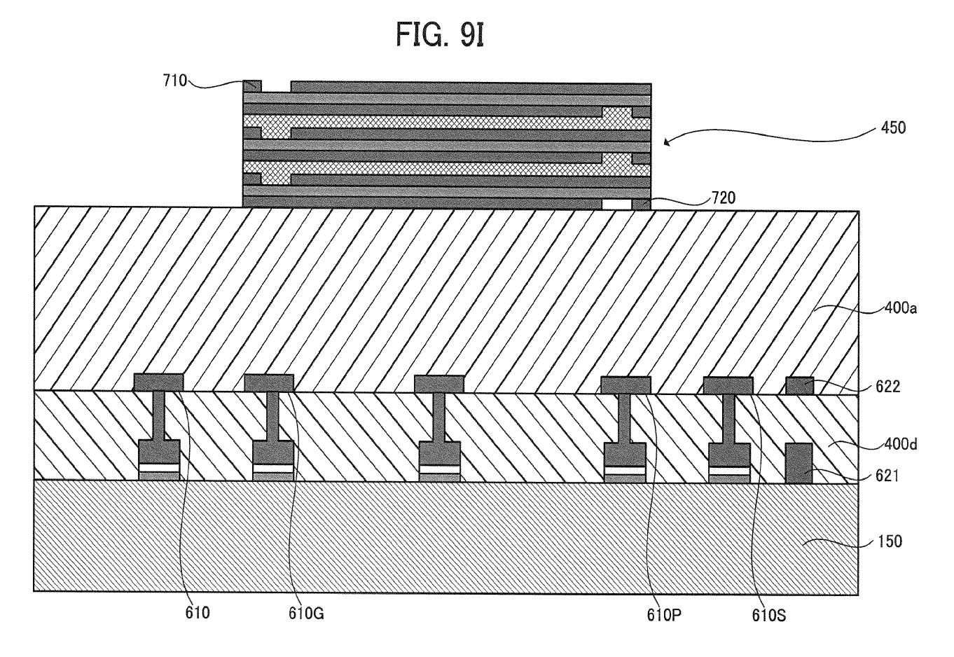

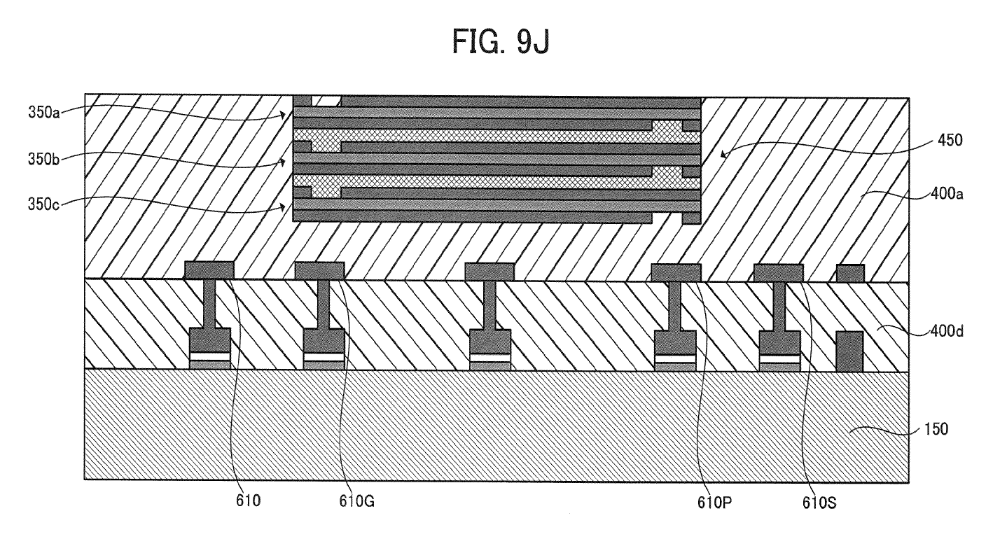

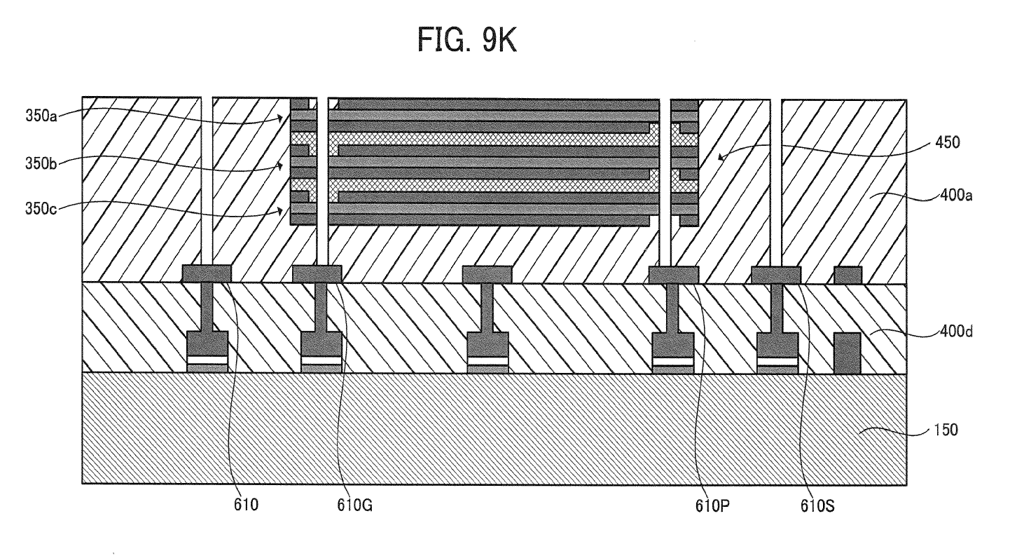

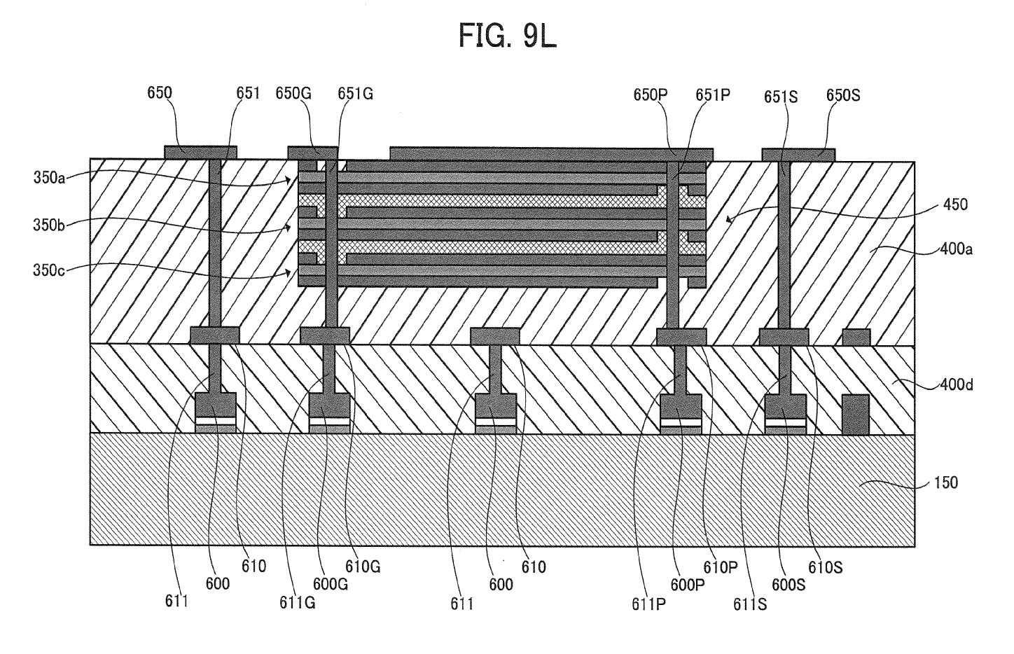

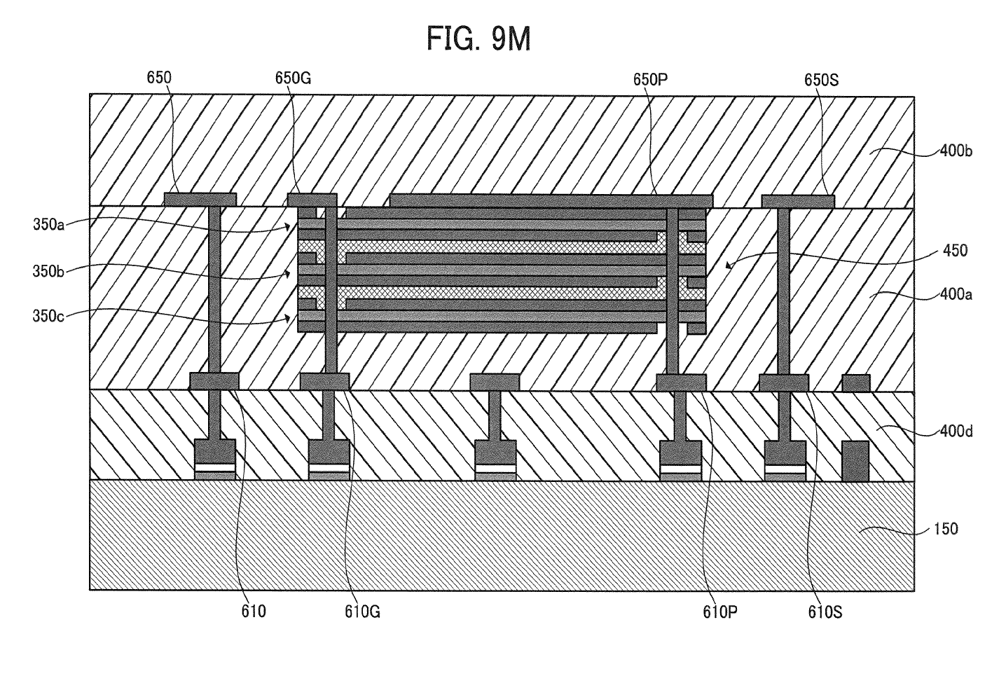

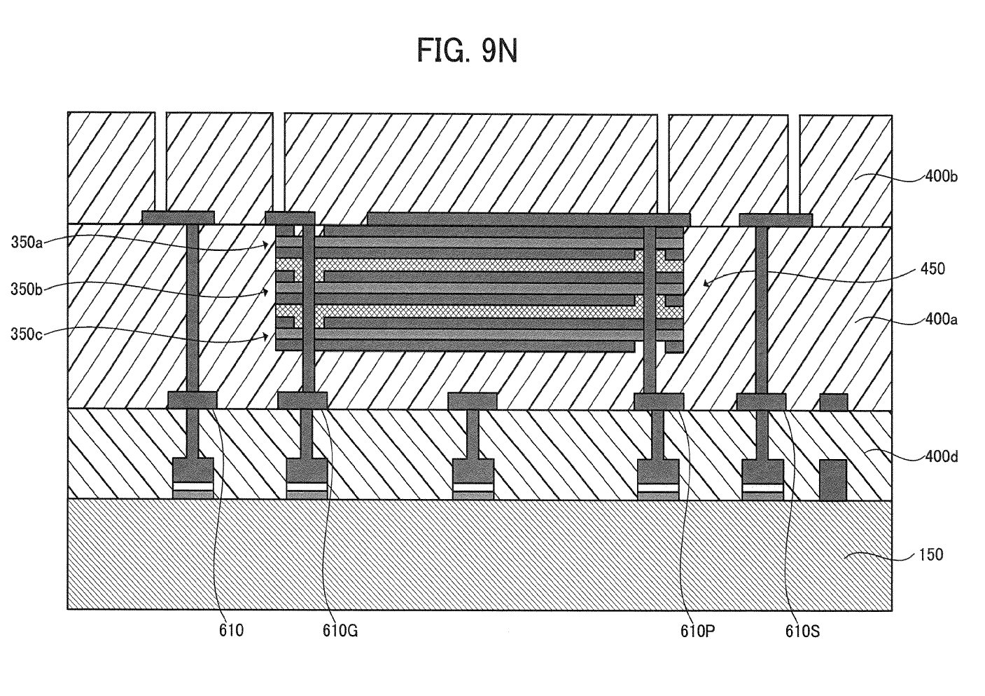

After that, second solder bumps are formed on the outer surfaces (exposed portions of the metal film) of second external connection terminals (670) (670P, 670G, 670S), and first solder bumps are formed on the outer surfaces of first external connection terminals (600) (600P, 600G, 600S). Accordingly, wiring board (900) is obtained as shown in FIG. 8).

Electronic components such as an IC chip may be mounted by means of the first solder bumps. The wiring board may be connected through the second solder bumps to the other substrate (motherboard). Also, in FIG. 8), solder bumps are formed on the outer surfaces of the first external connection terminals and on the outer surfaces of the second external connection terminals. However, solder bumps may be formed on the outer surfaces of the second external connection terminals, while conductive pins are installed (mounted) through solder on the outer surfaces of the first external connection terminals. Also, solder bumps may be formed on the outer surfaces of the first external connection terminals, while conductive pins are installed (mounted) through solder on the outer surfaces of the second external connection terminals. An IC chip may be mounted either on the upper-surface side or on the lower-surface side of the wiring board; however, an IC chip is preferred to be mounted on the surface of the board with a built-in capacitor where the distance between the external terminals and the capacitor (in the vertical direction of the board) is shorter.

In the present embodiment, there are three resin insulation layers (resin films). However, it is possible to make them multilayered with four or more layers by repeating the process from FIGS. (9M) to (9O).

In addition, it is also possible to form a solder resist having openings to expose first external connection terminals (600) (600P, 600G, 600S) beneath first lower resin insulation layer (400d).

Wiring board (900) shown in FIG. (10) is a different example from wiring board (900) shown in FIG. (8) in that first external connection terminals and the capacitor laminate are embedded in the same resin insulation layer. Wiring board (900) shown in FIG. (10) is a two-layered structure with first resin insulation layer (lowermost resin insulation layer) (400a) having a first surface and a second surface opposite the first surface, and second resin insulation layer (uppermost resin insulation layer) (400b) having a first surface and a second surface opposite the first surface. Capacitor laminate (450) is embedded in first resin insulation layer (400a) on its second-surface side. The surface of first electrode of capacitor (350a) is positioned at substantially the same level as the second-surface of the lowermost resin insulation layer. On the other hand, first external connection terminals (600) are embedded in first resin insulation layer (400a) on its first-surface side (the first surface of wiring board (900)). The surfaces of the first external terminals and the first surface of the lowermost resin insulation layer are positioned at substantially the same level. The first surface of the uppermost resin insulation layer is laminated on the second surface of the lowermost resin insulation layer. Formed on the second surface of second resin insulation layer (400b) are second external connection terminals (670) made up of second power-source external connection terminals (third external terminals) (670P), second ground external connection terminals (fourth external terminals) (670G) and second signal external connection terminals (670P). Also, via conductors are formed in second resin insulation layer (400b).

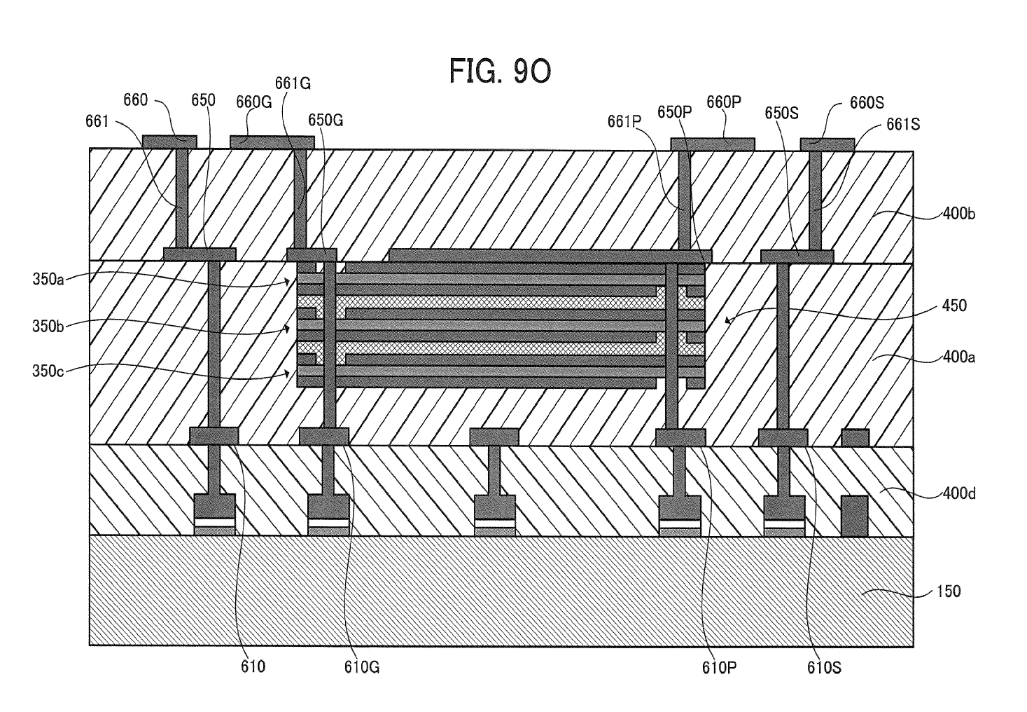

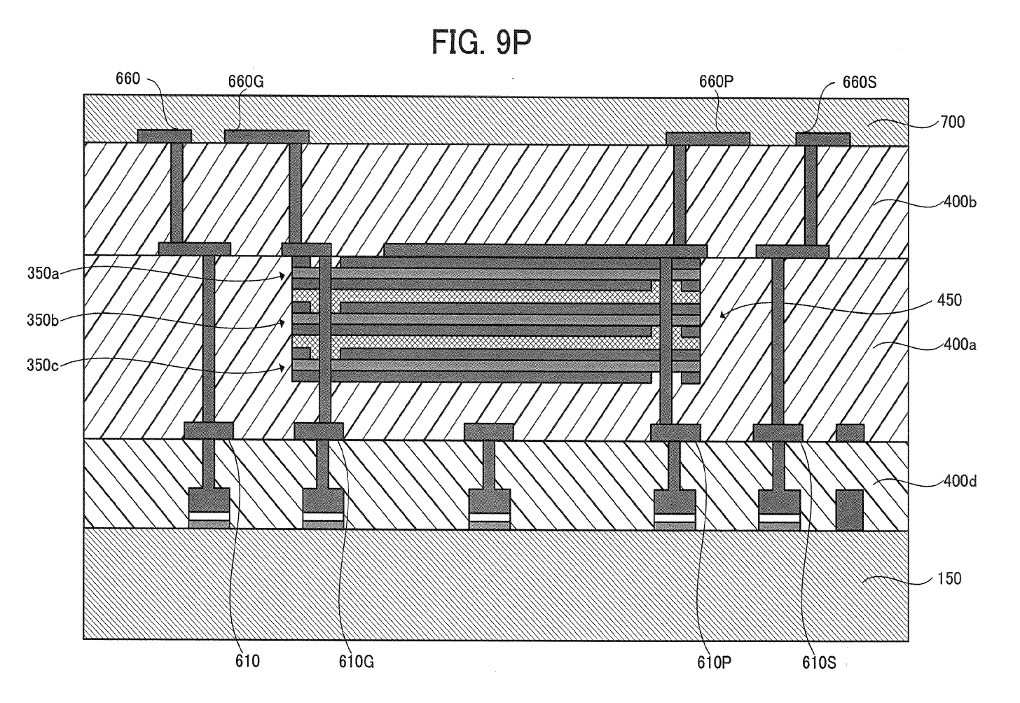

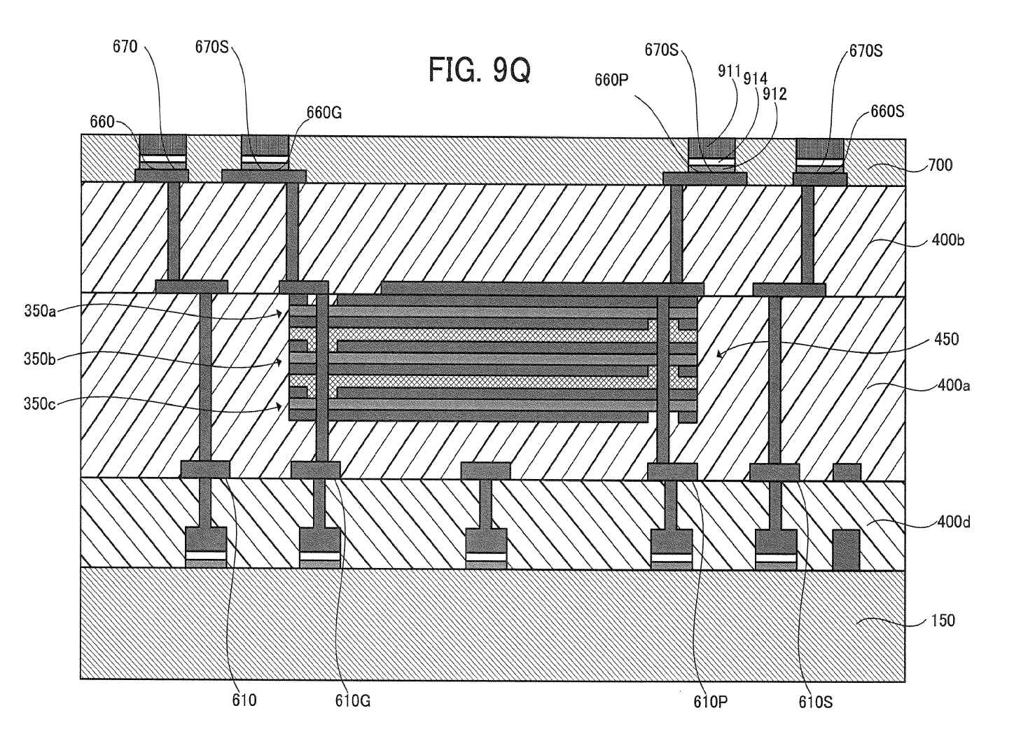

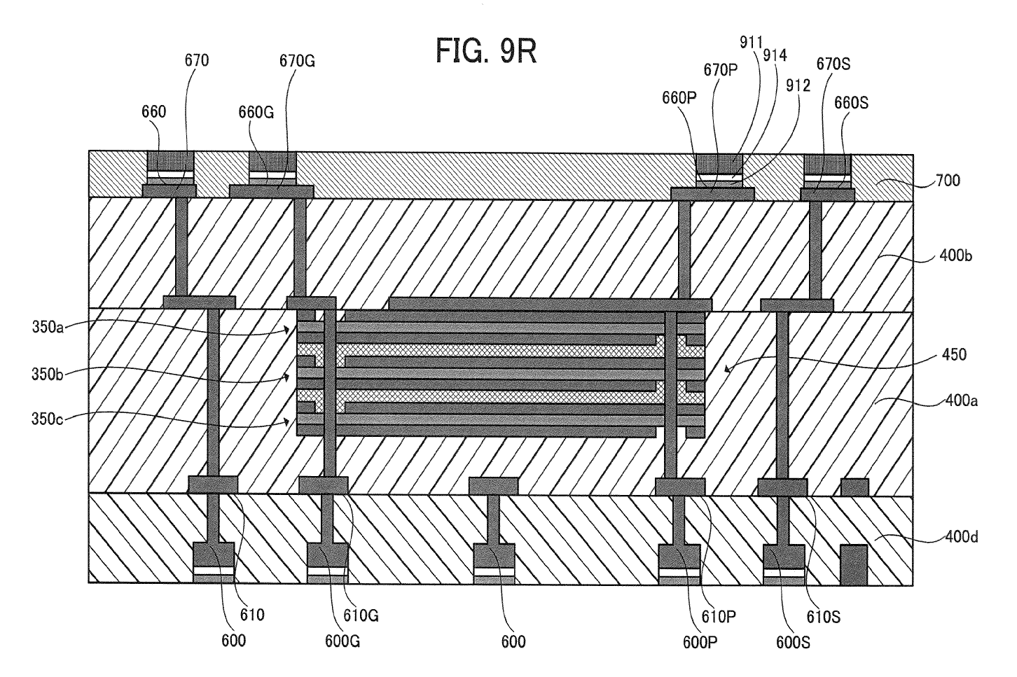

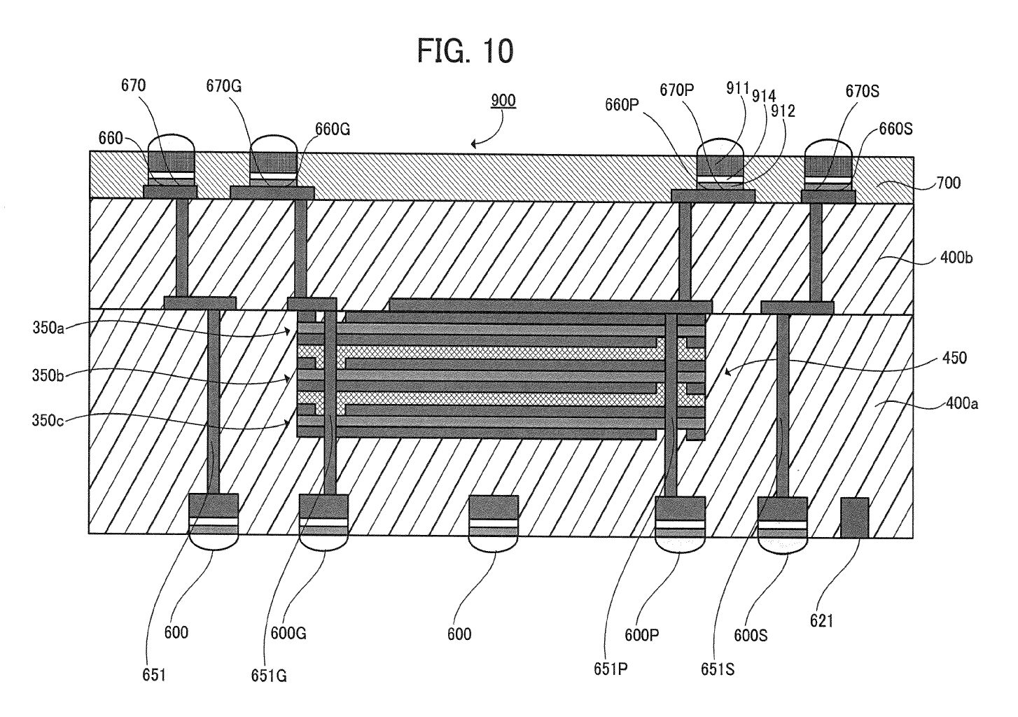

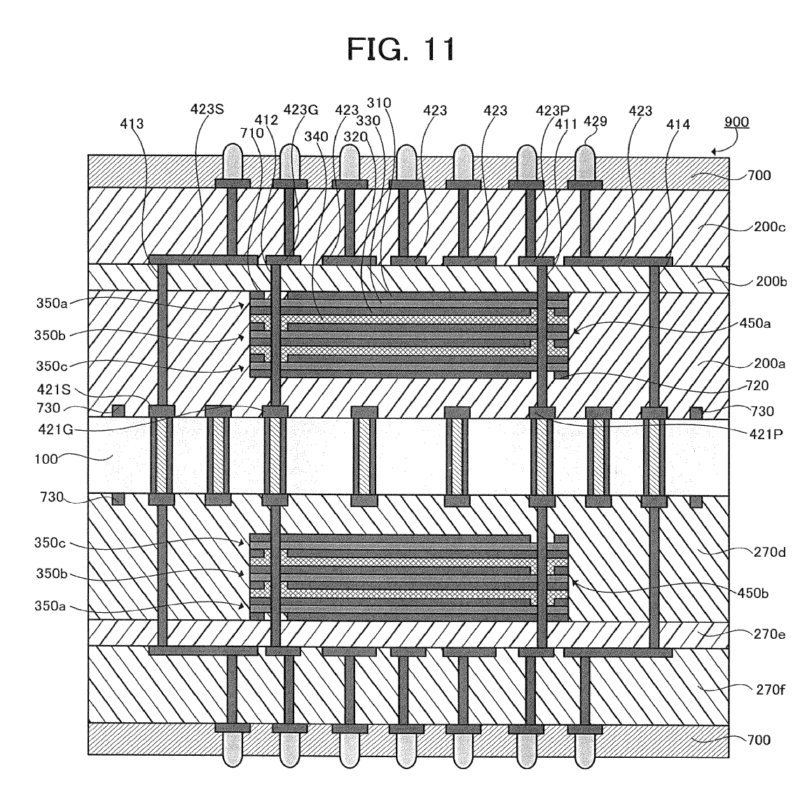

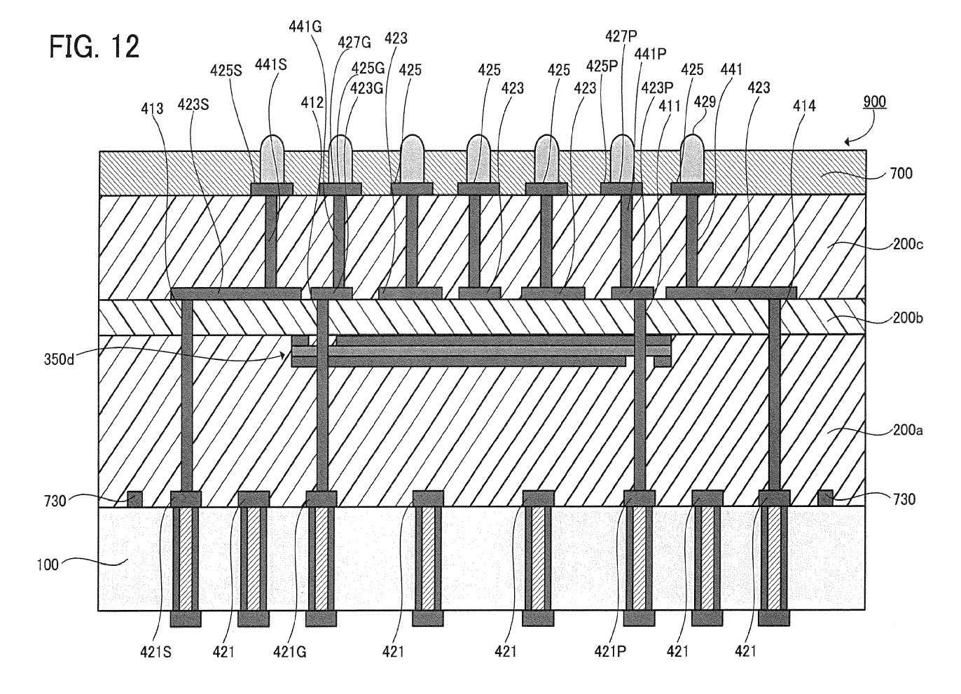

To manufacture wiring board (900) shown in FIG. 10), the steps shown in FIGS. (9A-9E) are conducted. Then, the steps shown in FIGS. (9I-9R) are conducted, plating resist (160) is removed and first solder bumps are formed in first external connection terminals (600) (600P, 600G, 600S). Accordingly, wiring board (900) is obtained as shown in FIG. (10).

The wiring board of the Fourth Embodiment, the same as in the Third Embodiment, may have a built-in capacitor laminate formed by using an adhesive agent to laminate capacitors, whose first electrodes and second electrodes are not shifted from each other in a direction parallel to their surfaces.

### (Fifth Embodiment of a Wiring Board According to the Present Invention)

Wiring board (900) according to the Fifth Embodiment of the present invention is different from wiring board (900) of the First Embodiment in that resin insulation layer (200a) is formed on base substrate (100) and lower resin insulation layer (270d) is formed beneath base substrate (100) as shown in FIG. (11). Capacitor laminate (450a) is embedded in resin insulation layer (200a), and capacitor laminate (450b) is embedded in lower resin insulation layer (270d).

By structuring as such, noise is efficiently reduced not only on base substrate (100), but beneath base substrate (100).

As for a method for manufacturing such wiring board (900), for example, after the step in FIG. (2W), lower resin insulation layer (270d) may be formed on the lower surface of base substrate (100) to embed capacitor laminate (450b) in lower resin insulation layer (270a).

### OTHER EMBODIMENTS OF THE PRESENT INVENTION

In the above embodiments, capacitor laminate (450) was formed by laminating three capacitors (350a, 350b, 350c). However, it is not limited to such; capacitor laminate (450) may be formed by laminating, for example, two or four to 30 or more capacitors using adhesive agent (340) between them.

In the above embodiments, dielectric layer (330) was formed with barium titanate (BaTiO₃). However, it is not limited to such; dielectric layer (330) may be formed with, for example, any of the following or their compounds: strontium titanate (SrTiO₃), tantalum oxide (TaO₃, Ta₂O₅), lead zirconate titanate (PZT), lead lanthanide zirconate titanate (PLZT), lead niobate zirconate titanate (PNZT), lead calcium zirconate titanate (PCZT) or strontium-doped lead zirconate titanate (PSZT).

In the above embodiments, strontium titanate (SrTiO₃) was used for dielectric filler. However, dielectric filler is not limited to such; for example, calcium titanate (CaTiO₃), magnesium titanate (Mg₂TiO₃), neodymium titanate (Nd₂Ti₂O₇) or the like may also be used.

Also, in the above embodiments, epoxy resin was used to form resin insulation layers (resin film). However, resin insulation layers are not limited to such; for example, any of the following resins may be used independently to form resin insulation layers: polyimide, polycarbonate, denaturated-polyphenylene ether, polyphenylene oxide, polybutylene terephthalate, polyacrylate, polysulfone, polyphenylene sulfide, polyetheretherketone, polysulfone, polyethersulfone, polyphenylsulfone, polyphthalamide, polyamide-imide, polyketon, polyacetal or the like. Alternatively, resin insulation layers may be formed by combining such with epoxy resin.

Also, in the above embodiments, copper was used as a metal to form first electrodes (310) and second electrodes (320). However, the material for electrodes is not limited to such. As for a metal to form first electrodes (310) and second electrodes (320), for example, it is possible to use independently or in combination any one of the following: platinum, gold, nickel, tin, silver or the like. In addition, the metals used for first electrodes (310) may differ from those used for second electrodes (320).

However, to suppress ion-migration at electrodes, it is efficient if nickel is used to form the electrodes (cathodes) for negative charge, and copper is used to form the electrodes (anodes) for positive charge. As such, by using a conductive material for the cathodes whose ionization tendency is greater than that of the conductive material for anodes, migration phenomena may be suppressed or prevented in the metals forming electrodes, especially anodes. Accordingly, deterioration of the insulation resistance at the capacitor section may be suppressed or prevented. Other than those, for example, even if cathodes are formed with nickel and anodes with tin, they may also achieve an effect the same as above or equivalent to such, as long as they satisfy the condition that the ionization tendency of the conductive material to form the cathodes is greater than that of the conductive material to form the cathodes.

Furthermore, anodes and cathodes are not limited to be formed as a single layer. For example, even if at least either the anodes or the cathodes are formed as multiple layers made of two or more different kinds of conductive materials, it is possible to suppress migration phenomena by arranging a metal with a greater ionization tendency for cathodes and a metal with a smaller ionization tendency for anodes.

Also, in the above embodiments, a high dielectric material was printed on first electrode (310) made of copper, and calcined to form dielectric layer (330). Then, a metal layer of copper was formed on dielectric layer (330) using vacuum deposition equipment such as sputtering to make it second electrode (320). Accordingly, a capacitor was formed, but formation of a capacitor is not limited to such.

Namely, a capacitor may be formed by the following steps: first, barium diethoxide and bitetra isopropoxide titanate are dissolved in a mixed solvent of dehydrated methanol and 2-methoxyethanol and blended under a nitrogen atmosphere at room temperature for three days to prepare a solution containing a precursor composition of barium-titanate alkoxide; then, the precursor composition solution is blended at a constant temperature of 0° C. to hydrolyze it by spraying decarbonated water at 0.5 micro liter/minute in a nitrogen current; then a sol-gel solution obtained through such a process is filtered to filter deposits or the like; the filtered solution is spincoated on first electrode (310) made of 12 μm-thick copper; dielectric layer (330) is obtained after calcining it in an electric furnace at a constant temperature of 850° C.; then, a copper layer is formed on dielectric layer (330) using vacuum deposition equipment such as sputtering, and copper of an approximate thickness of 10 μm is further added onto the copper layer through electrolytic plating or the like to obtain second electrode (320).

Other than capacitor devices having the above capacitor laminate, for example, as shown in FIG. (12), a capacitor device having a single-layered capacitor (350d) may be employed. Such a capacitor device has an advantage when manufacturing compact wiring boards or increasing the mounting efficiency of capacitors. When manufacturing such capacitor devices, by forming seed metal after a dry desmear treatment, and further forming copper-plated film, damage to dielectric layers is reduced and short-circuiting among capacitor electrodes may be suppressed.

Obviously, numerous modifications and variations of the present invention are possible in light of the above teachings. It is therefore to be understood that within the scope of the appended claims, the invention may be practiced otherwise than as specifically described herein.

What is claimed is:

1. A method of manufacturing a capacitor device, comprising:
forming at least one through-hole in a capacitor laminate made up of a plurality of laminated capacitors;
conducting a dry desmear treatment in the through-hole after forming the at least one through-hole; and
forming seed metal through dry processing in the at least one through-hole after conducting the dry desmear treatment.

2. The method of manufacturing a capacitor device according to claim 1, wherein the dry desmear treatment is conducted by dry etching.

3. The method of manufacturing a capacitor device according to claim 2, wherein the dry desmear treatment is conducted by dry etching using a reaction gas of O₂ and CF₄.

4. The method of manufacturing a capacitor device according to claim 1, wherein the dry processing in the forming the seed metal conducted through sputtering or deposition.

5. The method of manufacturing a capacitor device according to claim 1, wherein the forming the at least one through-hole is conducted by laser or drill.

6. The method of manufacturing a capacitor device according to claim 1, further comprising:
before forming the at least one through-hole, forming a capacitor having a dielectric layer, a first electrode for positive charge, and a second electrode facing the first electrode, with the dielectric layer being in between the first and second electrodes for negative charge; and
forming a capacitor laminate by laminating a plurality of capacitors formed in the forming a capacitor using an adhesive agent between the capacitors.

7. The method of manufacturing a capacitor device according to claim 6, further comprising:
forming a first via conductor electrically connecting the first electrodes, and a second via conductor electrically connecting the second electrodes, by plating on the seed metal and filling metal conductor in the at least one through-hole after forming the seed-metal; and
forming a first external terminal electrically connected to the first via conductor, and a second external terminal electrically connected to the second via conductor.

8. The method of manufacturing a capacitor device according to claim 6, wherein the first electrode is formed with a first conductive material and the second electrode is formed with a second conductive material, an ionization tendency of the second conductive material being greater than that of the first conductive material.

9. The method of manufacturing a capacitor device according to claim 8, wherein the first conductive material is copper and the second conductive material is nickel.

10. The method of manufacturing a capacitor device according to claim 1, wherein the forming the at least one through-hole is performed in a single-layer capacitor.

11. A method of manufacturing a capacitor device, comprising:
forming a capacitor having a dielectric layer, and a first electrode and a second electrode facing each other, with the dielectric layer being in between the first and second electrodes;
forming a capacitor laminate by laminating the capacitors with an adhesive agent;
forming on a support plate, first external connection terminals having a first external terminal and a second external terminal;
alternately laminating a plurality of resin insulation layers and a plurality of conductive circuits on the first external connection terminals and the support plate;
embedding the capacitor laminate in at least one resin insulation layer among the plurality of resin insulation layers;
forming in the capacitor laminate, at least one through-hole penetrating either first electrodes and second electrodes;
conducting a dry desmear treatment in the at least one through-hole;
forming seed metal through dry processing in the at least one through-hole after conducting the dry desmear treatment;
forming a first via conductor electrically connecting the first electrodes with each other, and a second via conductor electrically connecting the second electrodes with each other, by plating on the seed metal after forming the seed-metal and filling the at least one through-hole with metal conductor; and
forming a third external terminal electrically connected to the first via conductor, and a fourth external terminal electrically connected to the second via conductor.

12. A method of manufacturing a capacitor device, comprising:
forming a capacitor having a dielectric layer, and a first electrode and a second electrode facing each other, with the dielectric layer being in between the first and second electrodes;
forming a capacitor laminate by laminating the capacitors with an adhesive agent;
forming on a support plate, first external connection terminals having a first external terminal and a second external terminal;
alternately laminating a plurality of resin insulation layers and a plurality of conductive circuits on the first external connection terminals and the support plate;
embedding the capacitor laminate in at least one resin insulation layer among the plurality of resin insulation layers;
forming in the capacitor laminate, at least one through-hole penetrating either first electrodes and second electrodes;
conducting a dry desmear treatment in the at least one through-hole;
forming seed metal through dry processing in the at least one through-hole after conducting the dry desmear treatment;
forming a first via conductor electrically connecting the first electrodes with each other, and a second via conductor electrically connecting the second electrodes with each other, by plating on the seed metal after forming the seed-metal and filling the through-hole with metal conductor;
forming second external connection terminals having a third external terminal and a fourth external terminal on a resin insulation layer positioned uppermost among the plurality of resin insulation layers and opposite the support plate; and
removing the support plate, wherein
the first external terminal and the third external terminal are electrically connected to the first via conductor, and
the second external terminal and the fourth external terminal are electrically connected to the second via conductor.
